(19) United States
(12) Patent Application Publication
(10) Pub. No.: US 2026/0303423 A1
(43) Pub. Date: Oct. 1, 2026

(54) TERMINAL, BASE STATION, AND COMMUNICATION METHOD

(71) Applicant: Panasonic Intellectual Property Corporation of America, Torrance, CA (US)

(72) Inventors: Tetsuya YAMAMOTO, Kanagawa (JP); Hidetoshi SUZUKI, Kanagawa (JP)

(73) Assignee: Panasonic Intellectual Property Corporation of America, Torrance, CA (US)

(21) Appl. No.: 19/478,158

(22) PCT Filed: May 11, 2023
(86) PCT No.: PCT/JP2023/017671

§ 371 Date: Oct. 23, 2025

(51) Int. Cl. H04L 27/26; H04L 5/00; H04W 72/21

(52) U.S. Cl. CPC H04L 27/2602; H04L 5/0048; H04W 72/21

(57) ABSTRACT

This terminal comprises: a control circuit that switches the transmission waveform of an upstream signal to a first transmission waveform when conditions related to parameters and the configuration of the transmission of the upstream signal are satisfied; and a transmission circuit that transmits the upstream signal by using the first transmission waveform.

### TECHNICAL FIELD

The present disclosure relates to a terminal, a base station, and a communication method.

### BACKGROUND ART

In recent years, a dramatic growth of Internet of Things (IoT) has been expected with the expansion and diversification of radio services as a background. The usage of mobile communication is expanding to all fields such as automobiles, houses, home electric appliances, or industrial equipment in addition to information terminals such as smartphones. In order to support the diversification of services, a substantial improvement in the performance and function of mobile communication systems has been required for various requirements such as an increase in the number of connected devices or low latency in addition to an increase in system capacity. The 5th generation mobile communication system (5G) has features such as enhanced mobile broadband (eMBB), massive machine type communication (mMTC), and ultra reliable and low latency communication (URLLC), and flexibly provides radio communication in response to a wide variety of needs.

The 3rd Generation Partnership Project (3GPP) as an international standardizing body has been specifying New Radio (NR) as one of 5G radio interfaces.

### CITATION LIST

### Non-Patent Literature (Hereinafter, Referred to as “NPL”)

### NPL 1

3GPP TS38.104 V15.18.0, “NR Base Station (BS) radio transmission and reception (Release 15),” September 2022.

### NPL 2

RP-202928, “New WID on NR coverage enhancements,” China Telecom, December 2020.

### NPL 3

RP-220937, “Revised WID on Further NR coverage enhancements,” China Telecom, March 2022.

### NPL 4

3GPP TS38.211 V17.4.0, “NR Physical channels and modulation (Release 17),” December 2022.

### NPL 5

3GPP TS38.212 V17.5.0 , “NR Multiplexing and channel coding (Release 17),” March 2023.

### NPL 6

3GPP TS38.213 V17.5.0 , “NR Physical layer procedures for control (Release 17),” March 2023.

### NPL 7

3GPP TS38.214 V17.5.0 , “NR Physical layer procedures for data (Release 17),” March 2023.

### SUMMARY OF INVENTION

There is, however, room for consideration on a method for transmitting a signal in the uplink.

A non-limiting embodiment of the present disclosure facilitates providing a terminal, a base station, and a communication method each capable of appropriately transmitting a signal in the uplink.

A terminal according to an embodiment of the present disclosure includes: control circuitry, which, in operation, switches a transmission waveform of an uplink signal to a first transmission waveform in a case where a condition related to a parameter and a configuration of transmission of the uplink signal is satisfied; and transmission circuitry, which, in operation, transmits the uplink signal using the first transmission waveform.

It should be noted that general or specific embodiments may be implemented as a system, a method, an integrated circuit, a computer program, a storage medium, or any selective combination thereof.

According to an example of the present disclosure, a signal can be appropriately transmitted in the uplink.

Additional benefits and advantages of an example of the present disclosure will become apparent from the specification and drawings. Such advantages and/or effects are provided by each of several embodiments and features described in the specification and the drawings, but not all of them necessarily have to be provided in order to obtain one or more identical features.

### BRIEF DESCRIPTION OF DRAWINGS

FIG. 1 is a diagram illustrating an example of a method of determining a transmission waveform of a physical uplink shared channel (PUSCH);

FIG. 2 is a block diagram illustrating a configuration example of a part of a base station;

FIG. 3 is a block diagram illustrating a configuration example of a part of a terminal;

FIG. 4 is a flowchart illustrating an operation example of the terminal;

FIG. 5 is another flowchart illustrating the operation example of the terminal;

FIG. 6 is a block diagram illustrating a configuration example of the base station;

FIG. 7 is a block diagram illustrating a configuration example of the terminal;

FIG. 8 illustrates an exemplary architecture of a 3GPP NR system;

FIG. 9 is a schematic diagram illustrating a functional split between the NG-RAN and the 5GC;

FIG. 10 is a sequence diagram of a procedure for Radio Resource Control (RRC) connection setup/reconfiguration;

FIG. 11 schematically illustrates usage scenarios of enhanced Mobile BroadBand (eMBB), massive Machine Type Communications (mMTC), and Ultra Reliable and Low Latency Communications (URLLC); and

FIG. 12 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

In NR, for example, in addition to a frequency band of 6 GHz or less, mainly within the 700 MHz to 3.5 GHz bands (e.g., may be referred to as Frequency Range 1 (FR1)), which has been used for cellular communication, a millimeter-wave band such as the 28 GHz or 39 GHz band capable of ensuring a wide band (e.g., may be referred to as Frequency Range 2 (FR2)) can be utilized (e.g., see NPL 1). Further, for example, in FR1, a high frequency band is possibly used compared with the frequency band used in Long Term Evolution (LTE) or 3rd Generation mobile communication systems (3G) such as the 3.5 GHz band.

The higher the frequency band is, the greater a radio wave propagation loss is, and thus, the received quality of radio waves is likely to deteriorate. Hence, in NR, for example, it is expected to ensure almost the same communication area (or coverage) as in the Radio Access Technology (RAT) such LTE or 3G, in other words, to ensure an appropriate communication quality when the high frequency band is used compared with LTE or 3G. For example, in 3GPP Release 17 (e.g., referred to as “Rel. 17”) and Release 18 (e.g., referred to as “Rel.18”), methods for improving coverage in NR have been studied (see, e.g., NPLs 2 and 3).

In NR, a terminal (e.g., also referred to as user equipment (UE)) transmits and receives data according to, for example, a resource allocation indicated by a layer 1 control signal (e.g., Downlink Control Information (DCI)) on a downlink control channel (e.g., Physical Downlink Control Channel (PDCCH)) from a base station (e.g., also referred to as gNB), or Radio Resource Control (RRC), which is layer 3 (e.g., see NPLs 4 to 7).

In the uplink (Uplink (UL)), for example, a terminal transmits an uplink data channel (e.g., Physical Uplink Shared Channel (PUSCH)) in accordance with a resource allocation from a base station (e.g., Grant or UL grant).

In NR, Discrete Fourier Transform-spread-Orthogonal Frequency Division Multiplexing (DFT-s-OFDM) and Cyclic Prefix-OFDM (CP-OFDM) are supported as transmission waveforms of PUSCH.

DFT-s-OFDM has a lower Peak-to-Average Power Ratio (PAPR) of the transmission signal and higher power utilization efficiency than CP-OFDM, and thus has a transmission waveform that can ensure wide uplink coverage. In addition, CP-OFDM is highly compatible with Multiple-Input Multiple-Output (MIMO), and thus has a transmission waveform effective for high-efficiency transmission (e.g., multi-rank or multi-layer transmission in spatial multiplex transmission) in an environment with high received quality (e.g., SINR: Signal-to-Interference and Noise power Ratio).

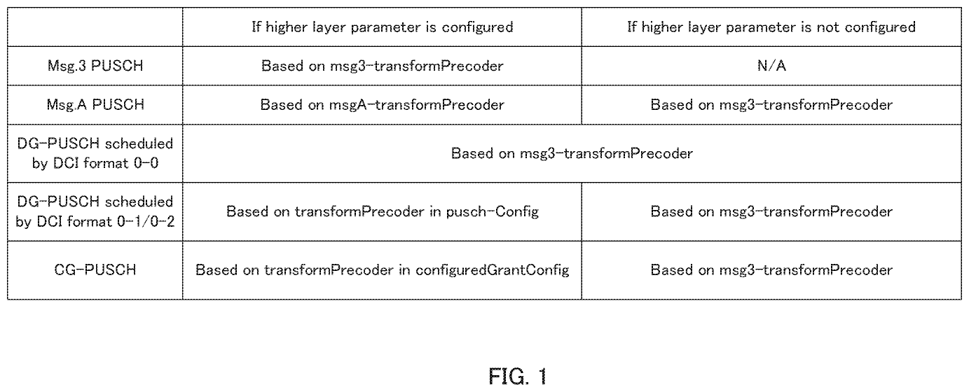

In NR up to Rel. 17, the transmission waveform of PUSCH is configured semi-statically via RRC. FIG. 1 illustrates an example of a method of determining a transmission waveform of a PUSCH in NR up to Rel. 17.

For example, the transmission waveform of Message 3 (Msg.3) PUSCH in a 4-step random access procedure is determined based on the parameter “msg3-transformPrecoder” configured via RRC.

Further, for example, the transmission waveform of Message A (Msg.A) PUSCH in a 2-step random access procedure is determined based on the parameter “msgA-transformPrecoder” configured via RRC. Note that, in a case where msgA-transformPrecoder is not configured via RRC, the transmission waveform of Msg.A PUSCH may be determined based on msg3-transformPrecoer.

Further, for example, the transmission waveform of PUSCH dynamically scheduled by DCI format 0-0 (e.g., DG-PUSCH: Dynamic Grant-PUSCH) is determined based on the parameter “msg3-transformPrecoder” configured via RRC.

Further, for example, the transmission waveform of PUSCH dynamically scheduled by DCI format 0-1 or DCI format 0-2 (e.g., DG-PUSCH) is determined based on the parameter “transformPrecoder” included in a pusch-Config information element (IE) configured via RRC. Note that, in a case where transformPrecoder is not configured via RRC, the transmission waveform of PUSCH dynamically scheduled by DCI format 0-1 or DCI format 0-2 may be determined based on msg3-transformPrecoder.

Further, for example, the transmission waveform of PUSCH that is transmitted based on a resource allocation indicated via RRC, which is layer 3, or based on semi-persistent resource allocation by Activation DCI (e.g., CG-PUSCH: Configured grant-PUSCH) is determined based on a parameter “transformPrecoder” included in a configuredGrantConfig IE configured via RRC. Note that, in a case where transformPrecoder is not configured via RRC, the transmission waveform of CG-PUSCH may be determined based on msg3-transformPrecoder.

In addition, in NR up to Release 17, the number of transmission layers of PUSCH transmission using DFT-s-OFDM is set (or limited) to one.

In a general cellular system, an operation is assumed in which DFT-s-OFDM is configured to ensure coverage for a terminal at the cell edge for which uplink coverage improvement is expected.

However, even for a terminal at the cell edge, there may be a situation in which the terminal transmits PUSCH by securing high received quality (for example, SINR) due to instantaneous variations in the channel or interference environment. In such a case, when the transmission waveform is semi-statically configured (e.g., when there is a restriction on the configuration), it is difficult for a terminal at the cell edge whose transmission waveform is configured to be DFT-s-OFDM, to switch the transmission waveform to CP-OFDM to perform high-efficiency transmission (e.g., multi-layer transmission by MIMO spatial multiplexing or the like) in response to the instantaneous variations in the channel or interference environment, and thus the transmission efficiency of the terminal at the cell edge is possibly not improved.

On the other hand, for example, in a case where the transmission waveform is configured to be CP-OFDM by transformPrecoder or msg3-transformPrecoder, prioritizing improvement of transmission efficiency, the coverage performance in the uplink possibly deteriorates in a terminal in a low SINR environment, such as a terminal at the cell edge.

For example, as a method of dynamically switching the transmission waveform of the PUSCH, a method of adding a field for indicating the transmission waveform (transmission waveform indication field) to DCI is exemplified. However, the introduction of the transmission waveform indication field in the DCI causes an increase in the number of DCI bits.

In addition, for example, in the case of the PUSCH scheduled by DCI format 0-0, it is desired that DCI format 0-0 can be used regardless of RRC reconfiguration. In addition, it is not desired to change the DCI size of DCI format 0-0 to maintain the same DCI payload size in a common search space between terminals of different releases. Therefore, the method of dynamically switching the transmission waveform by adding a transmission waveform indication field to the DCI is not suitable for the PUSCH scheduled by DCI format 0-0.

In addition, DCI format 0-2 is a DCI designed for URLLC, and it is desired to reduce the number of DCI bits as much as possible to improve the reliability of DCI reception. Therefore, the method of dynamically switching the transmission waveform by adding a transmission waveform indication field to the DCI is not suitable for the PUSCH scheduled by DCI format 0-2.

In a non-limiting example of the present disclosure, a method of dynamically switching the transmission waveform of PUSCH without adding a transmission waveform indication field to DCI will be described.

In a non-limiting example of the present disclosure, a terminal transmits PUSCH by switching the transmission waveform to DFT-s-OFDM in a condition related to the parameter or the configuration of PUSCH transmission. For example, information related to the parameter or the configuration of PUSCH transmission used for the condition for switching the transmission waveform may include at least one of information related to repetition transmission of the PUSCH, information related to the number of transmission layers, information related to frequency domain resource allocation, and/or information related to the configuration of a demodulation reference signal (DMRS). Accordingly, while achieving the improvement of the spectral efficiency or the transmission efficiency by CP-OFDM in general, the coverage can be secured by using DFT-s-OFDM at the cell edge or in a low SINR environment where the operational efficiency or the coverage performance deteriorates in CP-OFDM. In addition, it is possible to dynamically configure DFT-s-OFDM to secure the coverage without adding a transmission waveform indication field to DCI.

Hereinafter, non-limiting embodiments of the present disclosure will be described.

### Overview of Communication System

A communication system according to each embodiment of the present disclosure includes, for example, at least one base station and at least one terminal.

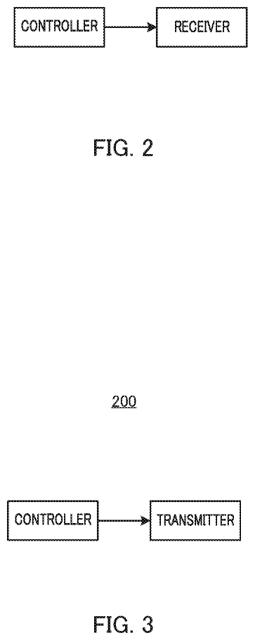

FIG. 2 is a block diagram illustrating a configuration example of a part of base station 100 according to an embodiment of the present disclosure, and FIG. 3 is a block diagram illustrating a configuration example of a part of terminal 200 according to an embodiment of the present disclosure.

In base station 100 illustrated in FIG. 2, a controller (for example, corresponding to control circuitry) switches a transmission waveform of an uplink signal (for example, PUSCH) to a first transmission waveform (for example, DFT-s-OFDM) in a case where a condition related to a parameter and a configuration of transmission of the uplink signal is satisfied. A receiver (for example, corresponding to reception circuitry) receives the uplink signal using the first transmission waveform.

In terminal 200 illustrated in FIG. 3, a controller (for example, corresponding to control circuitry) switches a transmission waveform of an uplink signal (for example, PUSCH) to a first transmission waveform (for example, DFT-s-OFDM) in a case where a condition related to a parameter and a configuration of transmission of the uplink signal is satisfied. A transmitter (for example, transmission circuitry) transmits the uplink signal using the first transmission waveform.

### Embodiment 1

Base station 100 (for example, base station/network), for example, configures a transmission waveform for terminal 200 semi-statically by transformPrecoder or msg3-transformPrecoder, which is a higher-layer parameter, in the same manner as in NR up to Rel. 17. For example, terminal 200 may have its semi-static transmission waveform configured to CP-OFDM by transformPrecoder or msg3-transformPrecoder.

In the present embodiment, terminal 200 transmits PUSCH by switching the transmission waveform to DFT-s-OFDM based on any one of the following conditions or a plurality of the following conditions.

### Condition 1: Enabling or Disabling of Repetition or Number of Repetitions

Terminal 200 may determine the switching of the transmission waveform of the PUSCH to DFT-s-OFDM based on, for example, the enabling or disabling of repetition in PUSCH transmission. For example, in a case where the repetition is applied to the PUSCH transmission, terminal 200 transmits the PUSCH by switching the transmission waveform to DFT-s-OFDM. On the other hand, in a case where the repetition is not applied to the PUSCH transmission, terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH to DFT-s-OFDM based on, for example, the number of repetitions (the number of times of repetition) of the PUSCH. For example, in a case where the number of repetitions is equal to or greater than N (or in a case where the number of repetitions is greater than N), terminal 200 transmits the PUSCH by switching the transmission waveform to DFT-s-OFDM. On the other hand, in a case where the number of repetitions is less than N (or in a case where the number of repetitions is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 2: Number of Transmission Layers

Terminal 200 may determine the switching of the transmission waveform of the PUSCH to DFT-s-OFDM based on, for example, the number of transmission layers (or the number of ranks) in the PUSCH transmission.

As described above, in the existing NR, DFT-s-OFDM supports single-layer transmission. In this case, for example, when the PUSCH transmission is a single-layer transmission, terminal 200 transmits the PUSCH by switching the transmission waveform to DFT-s-OFDM. On the other hand, when the PUSCH transmission is a multi-layer transmission, terminal 200 transmits the PUSCH by applying the transmission waveform (for example, CP-OFDM) that is configured semi-statically by transformPrecoder or msg3-transformPrecoder.

In addition, for example, in a case where DFT-s-OFDM supports multi-layer transmission, terminal 200 may switch the transmission waveform to DFT-s-OFDM based on the number of transmission layers being one or more. For example, in a case where the number of transmission layers is equal to or less than N (or in a case where the number of transmission layers is less than N), terminal 200 transmits the PUSCH by switching the transmission waveform to DFT-s-OFDM. On the other hand, in a case where the number of transmission layers is greater than N (or in a case where the number of transmission layers is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 3: Frequency Domain Resource Allocation Type, Number of Resource Blocks (RBs) Allocated in Frequency Domain, or Number of Clustered Resource Blocks

Terminal 200 may determine the switching of the transmission waveform of the PUSCH to DFT-s-OFDM based on, for example, the resource allocation (for example, frequency resource allocation) in the PUSCH transmission.

Terminal 200 may determine the switching of the transmission waveform of the PUSCH based on, for example, a frequency resource allocation type of the PUSCH transmission. For example, in a case where the frequency resource allocation type of the PUSCH transmission is Type 1 (for example, continuous RB allocation or allocation for which a starting RB and the number of RBs are indicated), terminal 200 transmits the PUSCH by switching the transmission waveform to DFT-s-OFDM. On the other hand, in a case where the PUSCH transmission is Type 0 (for example, non-continuous RB allocation or bitmap allocation by RB/RBG (RB group)), terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH based on, for example, the number of allocated RBs in the frequency domain resource allocation for the PUSCH transmission. For example, in a case where the number of allocated RBs is equal to or less than N (or in a case where the number of allocated RBs is less than N), terminal 200 transmits the PUSCH by switching the transmission waveform to DFT-s-OFDM. On the other hand, in a case where the number of allocated RBs is greater than N (or in a case where the number of allocated RBs is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of RBs constituting the cluster.

For example, in a case where the number of RBs constituting the cluster is equal to or less than N (or in a case where the number of RBs constituting the cluster is less than N), terminal 200 transmits the PUSCH by switching the transmission waveform to DFT-s-OFDM. On the other hand, in a case where the number of RBs constituting the cluster is greater than N (or in a case where the number of RBs constituting the cluster is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

In addition, the cluster used for determining the switching of the transmission waveform may be a cluster having the maximum number of RBs or a cluster having the minimum number of RBs. In addition, the cluster used for determining the switching of the transmission waveform may be a cluster having a specific index.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of clusters.

For example, in a case where the number of clusters is equal to or less than N (or in a case where the number of clusters is less than N), terminal 200 transmits the PUSCH by switching the transmission waveform to DFT-s-OFDM. On the other hand, in a case where the number of clusters is greater than N (or in a case where the number of clusters is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

### Condition 4: DMRS Type or Number of Additional DMRS Symbols

Terminal 200 may determine the switching of the transmission waveform of the PUSCH to DFT-s-OFDM based on, for example, the DMRS configuration in the PUSCH transmission.

Terminal 200 may determine the switching of the transmission waveform of the PUSCH based on, for example, the DMRS type in the PUSCH transmission. For example, in the existing NR, DFT-s-OFDM supports DMRS type=Type 1 and does not support DMRS type=Type 2. In this case, for example, in a case where the DMRS type of the PUSCH transmission is Type 1, terminal 200 transmits the PUSCH by switching the transmission waveform to DFT-s-OFDM. On the other hand, in a case where the DMRS type of the PUSCH transmission is Type 2, terminal 200 transmits the PUSCH by applying the transmission waveform (for example, CP-OFDM) that is configured semi-statically by transformPrecoder or msg3-transformPrecoder.

The DMRS type supported by DFT-s-OFDM is not limited to Type 1, and another type may be supported. In addition, the DMRS type is not limited to Type 1 and Type 2, and may include another type.

In addition, terminal 200 may determine the switching of the transmission waveform of the PUSCH based on, for example, the number of additional DMRS symbols in the DMRS configuration of the PUSCH transmission. For example, in a case where the number of additional DMRS symbols is equal to or greater than N (or in a case where the number of additional DMRS symbols is greater than N), terminal 200 transmits the PUSCH by switching the transmission waveform to DFT-s-OFDM. On the other hand, in a case where the number of additional DMRS symbols is less than N (or in a case where the number of additional DMRS symbols is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

The conditions related to the switching of the transmission waveform have been described above.

Terminal 200 may switch the transmission waveform of the PUSCH to DFT-s-OFDM based on, for example, any one of the four conditions described above. For example, terminal 200 may switch the transmission waveform of the PUSCH to DFT-s-OFDM based on Condition 1.

Alternatively, terminal 200 may switch the transmission waveform of the PUSCH to DFT-s-OFDM based on, for example, a plurality of conditions among the four conditions described above.

In a case where the plurality of conditions is used, for example, terminal 200 may switch the transmission waveform to DFT-s-OFDM when any one of the plurality of conditions satisfies the condition for switching the transmission waveform to DFT-s-OFDM. For example, in a case where the condition for switching the transmission waveform to DFT-s-OFDM is not satisfied in all of the plurality of conditions, terminal 200 may transmit the PUSCH by applying the transmission waveform (for example, CP-OFDM) that is configured semi-statically by transformPrecoder or msg3-transformPrecoder.

Alternatively, for example, in a case where the condition for switching the transmission waveform to DFT-s-OFDM is satisfied in all of the plurality of conditions, terminal 200 may switch the transmission waveform to DFT-s-OFDM. For example, in a case where any one of the plurality of conditions does not satisfy the condition for switching the transmission waveform to DFT-s-OFDM, terminal 200 may transmit the PUSCH by applying the transmission waveform (for example, CP-OFDM) that is configured semi-statically by transformPrecoder or msg3-transformPrecoder.

Furthermore, for example, in a case where M (or M or more) conditions among the plurality of conditions satisfy the condition for switching the transmission waveform to DFT-s-OFDM, terminal 200 may switch the transmission waveform to DFT-s-OFDM. Here, a value of M may be provided in advance on the standard, or may be configured (or indicated) to terminal 200 via RRC or another signal.

In addition, for example, which condition (one or a plurality of conditions) among the above-described four conditions to be used for switching the transmission waveform to DFT-s-OFDM (for example, information related to the condition to be applied) may be configured for (or indicated to) terminal 200 via RRC or another signal.

Here, the above-described conditions for switching the transmission waveform to DFT-s-OFDM are generally parameters or configurations of PUSCH transmission that can be applied to the PUSCH transmission in a low SINR environment. Terminal 200 transmitting the PUSCH by applying DFT-s-OFDM in a case where such a condition is satisfied is useful for improvement of the coverage and the transmission performance.

In addition, in the present embodiment, for example, information related to the parameter or the configuration of the PUSCH transmission (for example, information related to at least one of PUSCH repetition, the number of transmission layers, frequency domain resource allocation, and/or a DMRS configuration) may be indicated to terminal 200 by dynamic signaling such as DCI. Accordingly, in an environment where the improvement of the coverage and the transmission performance is expected, it is possible to dynamically switch the transmission waveform without the overhead of adding a transmission waveform indication field to DCI.

### Operation Example of Terminal 200

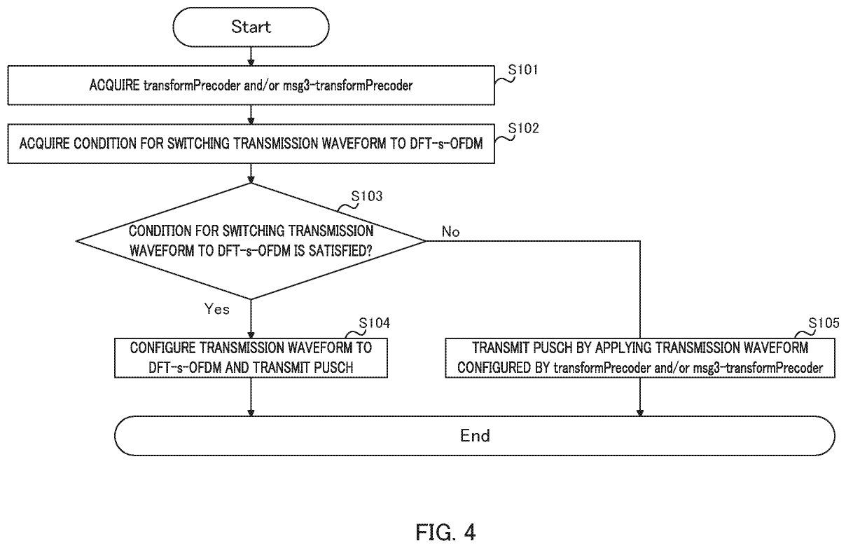

FIG. 4 is a flowchart illustrating an operation example of terminal 200.

In FIG. 4, terminal 200 acquires at least one of higher-layer parameters such as transformPrecoder or msg3-transformPrecoder (S101).

Terminal 200 acquires information related to the condition for switching the transmission waveform of PUSCH to DFT-s-OFDM (S102). The information related to the condition for switching the transmission waveform of PUSCH to DFT-s-OFDM may include, for example, information related to the condition to be applied among the four conditions described above, or may include information related to the parameters and the configurations (for example, Repetition, the number of layers, an RB configuration, a DMRS configuration, or a threshold) used in the four conditions described above.

Terminal 200 determines whether the condition for switching the transmission waveform of PUSCH to DFT-s-OFDM is satisfied (S103).

In a case where the condition for switching the transmission waveform of PUSCH to DFT-s-OFDM is satisfied (S103: Yes), terminal 200 configures (or switches) the transmission waveform of the PUSCH to DFT-s-OFDM, and transmits the PUSCH (S104).

On the other hand, in a case where the condition for switching the transmission waveform of PUSCH to DFT-s-OFDM is not satisfied (S103: No), terminal 200 transmits the PUSCH by applying the transmission waveform (for example, CP-OFDM) configured by at least one of transformPrecoder and/or msg3-transformPrecoder (S105).

As described above, in the present embodiment, in a case where the condition related to the parameter and the configuration of the PUSCH transmission is satisfied, terminal 200 switches the transmission waveform of the PUSCH to DFT-s-OFDM, and transmits the PUSCH using DFT-s-OFDM. For example, in a case where the transmission waveform of the PUSCH is configured to be CP-OFDM via the higher-layer parameter (for example, transformPrecoder or msg3-transformPrecoder), terminal 200 determines the switching to DFT-s-OFDM based on the condition.

Accordingly, terminal 200 can dynamically switch the transmission waveform of PUSCH, for example, depending on the instantaneous variations in the channel or interference environment, without adding a transmission waveform indication field to DCI. Thus, according to the present embodiment, terminal 200 can appropriately transmit a signal in the uplink.

### Variation 1

As described above, in NR, the transmission waveform of the PUSCH (DG-PUSCH) that is dynamically scheduled by DCI format 0-0 is determined based on msg3-transformPrecoder, which is a parameter configured via RRC.

In addition, the transmission waveform of the PUSCH (DG-PUSCH) that is dynamically scheduled by DCI format 0-1 or DCI format 0-2 is determined based on transformPrecoder, which is a parameter included in pusch-Config IE configured via RRC. In addition, in a case where transformPrecoder is not configured via RRC, the transmission waveform of the PUSCH that is dynamically scheduled by DCI format 0-1 or DCI format 0-2 is determined based on msg3-transformPrecoder.

In addition, the transmission waveform of the PUSCH (CG-PUSCH) for transmitting the PUSCH with the resource allocation indicated via RRC that is the layer 3 or the semi-static resource allocation by the activation DCI, is determined based on transformPrecoder, which is a parameter included in configuredGrantConfig IE configured via RRC. In addition, in a case where transformPrecoder is not configured via RRC, the transmission waveform of the CG-PUSCH is determined based on msg3-transformPrecoder.

In Variation 1, for example, the method of Embodiment 1 described above may be applied to the determination of the default transmission waveform.

Here, the determination of the default transmission waveform refers to a case where the transmission waveform is determined based on msg3-transformPrecoder. For example, the determination of the default transmission waveform may be at least one of the determination of the transmission waveform of the PUSCH (DG-PUSCH) that is dynamically scheduled by DCI format 0-0, the determination of the transmission waveform of the PUSCH that is dynamically scheduled by DCI format 0-1 or DCI format 0-2 in a case where transformPrecoder is not configured via RRC, and/or the determination of the transmission waveform of the CG-PUSCH in a case where transformPrecoder is not configured via RRC.

Base station 100 (for example, base station/network) semi-statically configures the transmission waveform for terminal 200 by transformPrecoder or msg3-transformPrecoder, which is a higher-layer parameter, for example, in the same manner as in NR up to Rel. 17.

For example, terminal 200 may have its semi-static transmission waveform configured to CP-OFDM for at least one of the PUSCH that is dynamically scheduled by DCI format 0-0, the PUSCH that is dynamically scheduled by DCI format 0-1 or DCI format 0-2 in a case where transformPrecoder is not configured via RRC, and/or the CG-PUSCH in a case where transformPrecoder is not configured via RRC.

In Variation 1, terminal 200 may determine the switching of the transmission waveform of the PUSCH to DFT-s-OFDM based on the conditions described in Embodiment 1, in a case of determining the default transmission waveform (for example, in a case where msg3-transformPrecoder is configured and transformPrecoder is not configured). On the other hand, in a case of determining the transmission waveform different from the default transmission waveform (for example, in a case where msg3-transformPrecoder and transformPrecoder are configured), terminal 200 may determine the transmission waveform based on transformPrecoder.

For example, terminal 200 may transmit the PUSCH by switching the transmission waveform of at least one of the PUSCH that is dynamically scheduled by DCI format 0-0, the PUSCH that is dynamically scheduled by DCI format 0-1 or DCI format 0-2 in a case where transformPrecoder is not configured via RRC, and/or the CG-PUSCH in a case where transformPrecoder is not configured via RRC, to DFT-s-OFDM, based on any one of the following conditions or a plurality of the following conditions.

### Condition 1: Whether Repetition is Applied or Not or Number of Repetitions

Terminal 200 may determine the switching of the transmission waveform of the PUSCH to DFT-s-OFDM based on, for example, the whether repetition is applied or not in the PUSCH transmission. For example, in a case where the repetition is applied to the PUSCH transmission, terminal 200 transmits the PUSCH by switching the transmission waveform to DFT-s-OFDM. On the other hand, in a case where the repetition is not applied to the PUSCH transmission, terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH to DFT-s-OFDM based on, for example, the number of repetitions (the number of times of repetition) of the PUSCH. For example, in a case where the number of repetitions is equal to or greater than N (or in a case where the number of repetitions is greater than N), terminal 200 transmits the PUSCH by switching the transmission waveform to DFT-s-OFDM. On the other hand, in a case where the number of repetitions is less than N (or in a case where the number of repetitions is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 2: Number of Transmission Layers

Terminal 200 may determine the switching of the transmission waveform of the PUSCH to DFT-s-OFDM based on, for example, the number of transmission layers (or the number of ranks) in the PUSCH transmission.

As described above, in the existing NR, DFT-s-OFDM supports single-layer transmission. In this case, for example, in a case where the PUSCH transmission is a single-layer transmission, terminal 200 transmits the PUSCH by switching the transmission waveform to DFT-s-OFDM. On the other hand, in a case where the PUSCH transmission is a multi-layer transmission, terminal 200 transmits the PUSCH by applying the transmission waveform (for example, CP-OFDM) that is configured semi-statically by transformPrecoder or msg3-transformPrecoder.

Alternatively, for example, in a case where DFT-s-OFDM supports multi-layer transmission, terminal 200 may switch the transmission waveform to DFT-s-OFDM based on the number of transmission layers being one or more. For example, in a case where the number of transmission layers is equal to or less than N (or in a case where the number of transmission layers is less than N), terminal 200 transmits the PUSCH by switching the transmission waveform to DFT-s-OFDM. On the other hand, in a case where the number of transmission layers is greater than N (or in a case where the number of transmission layers is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 3: Frequency Domain Resource Allocation Type, Number of Resource Blocks (RBs) Allocated in Frequency Domain, or Number of Clustered Resource Blocks

Terminal 200 may determine the switching of the transmission waveform of the PUSCH to DFT-s-OFDM based on, for example, the resource allocation (for example, frequency resource allocation) in the PUSCH transmission.

Terminal 200 may determine the switching of the transmission waveform of the PUSCH based on, for example, a frequency resource allocation type of the PUSCH transmission. For example, in a case where the frequency resource allocation type of the PUSCH transmission is Type 1 (for example, continuous RB allocation or allocation for which a starting RB and the number of RBs are indicated), terminal 200 transmits the PUSCH by switching the transmission waveform to DFT-s-OFDM. On the other hand, in a case where the PUSCH transmission is Type 0 (for example, non-continuous RB allocation or bitmap allocation by RB/RBG (RB group)), terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH based on, for example, the number of allocated RBs in the frequency domain resource allocation for the PUSCH transmission. For example, in a case where the number of allocated RBs is equal to or less than N (or in a case where the number of allocated RBs is less than N), terminal 200 transmits the PUSCH by switching the transmission waveform to DFT-s-OFDM. On the other hand, in a case where the number of allocated RBs is greater than N (or in a case where the number of allocated RBs is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of RBs constituting the cluster.

For example, in a case where the number of RBs constituting the cluster is equal to or less than N (or in a case where the number of RBs constituting the cluster is less than N), terminal 200 transmits the PUSCH by switching the transmission waveform to DFT-s-OFDM. On the other hand, in a case where the number of RBs constituting the cluster is greater than N (or in a case where the number of RBs constituting the cluster is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

In addition, the cluster used for determining the switching of the transmission waveform may be a cluster having the maximum number of RBs or a cluster having the minimum number of RBs. In addition, the cluster used for determining the switching of the transmission waveform may be a cluster having a specific index.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of clusters.

For example, in a case where the number of clusters is equal to or less than N (or in a case where the number of clusters is less than N), terminal 200 transmits the PUSCH by switching the transmission waveform to DFT-s-OFDM. On the other hand, in a case where the number of clusters is greater than N (or in a case where the number of clusters is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

### Condition 4: DMRS Type or Number of Additional DMRS Symbols

Terminal 200 may determine the switching of the transmission waveform of the PUSCH to DFT-s-OFDM based on, for example, the DMRS configuration in the PUSCH transmission.

Terminal 200 may determine the switching of the transmission waveform of the PUSCH based on, for example, the DMRS type in the PUSCH transmission. For example, in the existing NR, DFT-s-OFDM supports DMRS type=Type 1 and does not support DMRS type=Type 2. In this case, for example, in a case where the DMRS type of the PUSCH transmission is Type 1, terminal 200 transmits the PUSCH by switching the transmission waveform to DFT-s-OFDM. On the other hand, in a case where the DMRS type of the PUSCH transmission is Type 2, terminal 200 transmits the PUSCH by applying the transmission waveform (for example, CP-OFDM) that is configured semi-statically by transformPrecoder or msg3-transformPrecoder.

The DMRS type supported by DFT-s-OFDM is not limited to Type 1, and another type may be supported. In addition, the DMRS type is not limited to Type 1 and Type 2, and may include another type.

In addition, terminal 200 may determine the switching of the transmission waveform of the PUSCH based on, for example, the number of additional DMRS symbols in the DMRS configuration of the PUSCH transmission.

For example, in a case where the number of additional DMRS symbols is equal to or greater than N (or in a case where the number of additional DMRS symbols is greater than N), terminal 200 transmits the PUSCH by switching the transmission waveform to DFT-s-OFDM. On the other hand, in a case where the number of additional DMRS symbols is less than N (or in a case where the number of additional DMRS symbols is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

The conditions related to the switching of the transmission waveform have been described above.

Terminal 200 may switch the transmission waveform of the PUSCH to DFT-s-OFDM based on, for example, any one of the four conditions described above. For example, terminal 200 may switch the transmission waveform of the PUSCH to DFT-s-OFDM based on Condition 1.

Alternatively, terminal 200 may switch the transmission waveform of the PUSCH to DFT-s-OFDM based on, for example, a plurality of conditions among the four conditions described above.

In a case where the plurality of conditions is used, for example, terminal 200 may switch the transmission waveform to DFT-s-OFDM when any one of the plurality of conditions satisfies the condition for switching the transmission waveform to DFT-s-OFDM. For example, in a case where the condition for switching the transmission waveform to DFT-s-OFDM is not satisfied in all of the plurality of conditions, terminal 200 may transmit the PUSCH by applying the transmission waveform (for example, CP-OFDM) that is configured semi-statically by transformPrecoder or msg3-transformPrecoder.

Alternatively, for example, terminal 200 may switch the transmission waveform to DFT-s-OFDM when the condition for switching the transmission waveform to DFT-s-OFDM is satisfied in all of the plurality of conditions. For example, in a case where any one of the plurality of conditions does not satisfy the condition for switching the transmission waveform to DFT-s-OFDM, terminal 200 may transmit the PUSCH by applying the transmission waveform (for example, CP-OFDM) that is configured semi-statically by transformPrecoder or msg3-transformPrecoder.

Furthermore, for example, in a case where M (or M or more) conditions among the plurality of conditions satisfy the condition for switching the transmission waveform to DFT-s-OFDM, terminal 200 may switch the transmission waveform to DFT-s-OFDM. Here, a value of M may be provided in advance on the standard, or may be configured (or indicated) to terminal 200 via RRC or another signal.

In addition, for example, terminal 200 may be configured (or indicated) via RRC or another signal regarding which condition (one or a plurality of conditions) among the above-described four conditions is used for switching the transmission waveform to DFT-s-OFDM (for example, information related to the condition to be applied).

The method of determining the default transmission waveform (for example, the transmission waveform of the PUSCH (DG-PUSCH) that is dynamically scheduled by DCI format 0-0, the transmission waveform of the PUSCH that is dynamically scheduled by DCI format 0-1 or DCI format 0-2 in a case where transformPrecoder is not configured via RRC, and the transmission waveform of the CG-PUSCH in a case where transformPrecoder is not configured via RRC) has been described above.

On the other hand, for example, the transmission waveform configured semi-statically by transformPrecoder may be applied to the transmission waveform of the PUSCH that is dynamically scheduled by DCI format 0-1 or DCI format 0-2 in a case where transformPrecoder is configured via RRC, and the transmission waveform of the CG-PUSCH.

As described above, according to Variation 1, it is possible to dynamically switch the transmission waveform (for example, the default transmission waveform) of the PUSCH determined based on msg3-transformPrecoder, which is cell-specific RRC, without the overhead of adding a transmission waveform indication field to DCI in an environment in which the improvement of the coverage or the transmission performance is expected.

### Embodiment 2

As described above, in NR, the transmission waveform of Msg.3 PUSCH is determined based on Msg.3-transformPrecoder, which is a parameter configured via RRC. As described above, the transmission waveform of the Msg.3 PUSCH is determined based on Msg.3-transformPrecoder, which is a parameter configured by cell-specific RRC. Therefore, for example, in a case where DFT-s-OFDM, which is a transmission waveform suitable for a terminal for which the coverage is expected to be secured, is configured by cell-specific RRC, it is difficult for the terminal that can transmit Msg.3 PUSCH by securing a high SINR, to perform high-efficiency transmission using CP-OFDM, which possibly degrades the spectral efficiency of the entire cell. On the other hand, in a case where CP-OFDM is configured by cell-specific RRC, the coverage performance of the terminal at the cell edge may deteriorate.

Therefore, in the present embodiment, in a case where terminal 200 transmits PRACH (or Message 1 (Msg.1)) by applying multiple physical random access channel (PRACH) transmission or PRACH repetition, terminal 200 determines the transmission waveform of the Msg.3 PUSCH to DFT-s-OFDM by ignoring the configuration of the transmission waveform by Msg.3-transformPrecoder. On the other hand, in a case where terminal 200 transmits the PRACH without applying the multiple PRACH transmission or the PRACH repetition, terminal 200 determines the transmission waveform of the Msg.3 PUSCH in accordance with the configuration of Msg.3-transformPrecoder.

Here, terminal 200 that supports the capability of multiple PRACH transmission or PRACH repetition may also support, for example, a capability of selecting the transmission waveform without depending on the indication of Msg.3-transformPrecoder. The capability of selecting the transmission waveform without depending on the indication of Msg.3-transformPrecoder may be a capability of dynamically switching the transmission waveform of Msg.3 PUSCH, or may be a capability of ignoring the configuration of CP-OFDM by Msg.3-transformPrecoder for the Msg.3 PUSCH.

In general, different RACH resources are used for a RACH resource for the PRACH to which repetition is not applied and a RACH resource for the PRACH to which multiple PRACH transmission or PRACH repetition is applied. Therefore, according to the present embodiment, base station 100 can identify, according to whether RACH repetition is applied or not, the transmission waveform of the Msg.3 PUSCH (for example, DFT-s-OFDM or the transmission waveform based on msg3-transformPrecoder) transmitted by terminal 200. In addition, an additional RACH resource for base station 100 to identify the transmission waveform of the Msg.3 PUSCH is not required.

In addition, in the present embodiment, in a case where terminal 200 determines the transmission waveform of the Msg.3 PUSCH (for example, a signal in a random access procedure) to DFT-s-OFDM by ignoring the configuration of Msg.3-transformPrecoder in the determination of the transmission waveform of the Msg.3 PUSCH, the method of Embodiment 1 may be applied to the determination of the transmission waveform for the PUSCH (for example, DG-PUSCH or CG-PUSCH) after the random access procedure.

On the other hand, in a case where terminal 200 determines the transmission waveform of the Msg.3 PUSCH in accordance with the configuration of Msg.3-transformPrecoder in the determination of the transmission waveform of the Msg.3 PUSCH, terminal 200 may apply the transmission waveform that is configured semi-statically by transformPrecoder or Msg.3-transformPrecoder to the PUSCH (for example, DG-PUSCH or CG-PUSCH) after the random access procedure.

For example, base station 100 (for example, base station/network) semi-statically configures the transmission waveform for terminal 200 by transformPrecoder or Msg.3-transformPrecoder, which is a higher-layer parameter, in the same manner as in NR up to Rel. 17. For example, terminal 200 may have its semi-static transmission waveform configured to CP-OFDM by transformPrecoder or Msg.3-transformPrecoder.

In the present embodiment, in a case where terminal 200 determines the transmission waveform of the Msg.3 PUSCH to DFT-s-OFDM by ignoring the configuration of Msg.3-transformPrecoder in the determination of the transmission waveform of the Msg.3 PUSCH, terminal 200 determines the switching of the transmission waveform of the PUSCH transmitted after the Msg.3 PUSCH to DFT-s-OFDM based on any one of the following conditions or a plurality of the following conditions.

### Condition 1: Whether Repetition is Applied or Not or Number of Repetitions

Terminal 200 may determine the switching of the transmission waveform of the PUSCH to DFT-s-OFDM based on, for example, the whether repetition is applied or not in the PUSCH transmission. For example, in a case where the repetition is applied to the PUSCH transmission, terminal 200 transmits the PUSCH by switching the transmission waveform to DFT-s-OFDM. On the other hand, in a case where the repetition is not applied to the PUSCH transmission, terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH to DFT-s-OFDM based on, for example, the number of repetitions (the number of times of repetition) of the PUSCH. For example, in a case where the number of repetitions is equal to or greater than N (or in a case where the number of repetitions is greater than N), terminal 200 transmits the PUSCH by switching the transmission waveform to DFT-s-OFDM. On the other hand, in a case where the number of repetitions is less than N (or in a case where the number of repetitions is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 2: Number of Transmission Layers

Terminal 200 may determine the switching of the transmission waveform of the PUSCH to DFT-s-OFDM based on, for example, the number of transmission layers (or the number of ranks) in the PUSCH transmission.

As described above, in the existing NR, DFT-s-OFDM supports single-layer transmission. In this case, for example, when the PUSCH transmission is a single-layer transmission, terminal 200 transmits the PUSCH by switching the transmission waveform to DFT-s-OFDM. On the other hand, when the PUSCH transmission is a multi-layer transmission, terminal 200 transmits the PUSCH by applying the transmission waveform (for example, CP-OFDM) that is configured semi-statically by transformPrecoder or msg3-transformPrecoder.

In addition, for example, in a case where DFT-s-OFDM supports multi-layer transmission, terminal 200 may switch the transmission waveform to DFT-s-OFDM based on the number of transmission layers being one or more. For example, in a case where the number of transmission layers is equal to or less than N (or in a case where the number of transmission layers is less than N), terminal 200 transmits the PUSCH by switching the transmission waveform to DFT-s-OFDM. On the other hand, in a case where the number of transmission layers is greater than N (or in a case where the number of transmission layers is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 3: Frequency Domain Resource Allocation Type, Number of Resource Blocks (RBs) Allocated in Frequency Domain, or Number of Clustered Resource Blocks

Terminal 200 may determine the switching of the transmission waveform of the PUSCH to DFT-s-OFDM based on, for example, the resource allocation (for example, the frequency resource allocation) in the PUSCH transmission.

Terminal 200 may determine the switching of the transmission waveform of the PUSCH based on, for example, a frequency resource allocation type of the PUSCH transmission. For example, in a case where the frequency resource allocation type of the PUSCH transmission is Type 1 (for example, continuous RB allocation or allocation for which a starting RB and the number of RBs are indicated), terminal 200 transmits the PUSCH by switching the transmission waveform to DFT-s-OFDM. On the other hand, in a case where the PUSCH transmission is Type 0 (for example, non-continuous RB allocation or bitmap allocation by RB/RBG (RB group)), terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH based on, for example, the number of allocated RBs in the frequency domain resource allocation of the PUSCH transmission. For example, in a case where the number of allocated RBs is equal to or less than N (or in a case where the number of allocated RBs is less than N), terminal 200 transmits the PUSCH by switching the transmission waveform to DFT-s-OFDM. On the other hand, in a case where the number of allocated RBs is greater than N (or in a case where the number of allocated RBs is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of RBs constituting the cluster.

For example, in a case where the number of RBs constituting the cluster is equal to or less than N (or in a case where the number of RBs constituting the cluster is less than N), terminal 200 transmits the PUSCH by switching the transmission waveform to DFT-s-OFDM. On the other hand, in a case where the number of RBs constituting the cluster is greater than N (or in a case where the number of RBs constituting the cluster is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

In addition, the cluster used for determining the switching of the transmission waveform may be a cluster having the maximum number of RBs or a cluster having the minimum number of RBs. In addition, the cluster used for determining the switching of the transmission waveform may be a cluster having a specific index.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of clusters.

For example, in a case where the number of clusters is equal to or less than N (or in a case where the number of clusters is less than N), terminal 200 transmits the PUSCH by switching the transmission waveform to DFT-s-OFDM. On the other hand, in a case where the number of clusters is greater than N (or in a case where the number of clusters is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

### Condition 4: DMRS Type or Number of Additional DMRS Symbols

Terminal 200 may determine the switching of the transmission waveform of the PUSCH to DFT-s-OFDM based on, for example, the DMRS configuration in the PUSCH transmission.

Terminal 200 may determine the switching of the transmission waveform of the PUSCH based on, for example, the DMRS type in the PUSCH transmission. For example, in the existing NR, DFT-s-OFDM supports DMRS type=Type 1 and does not support DMRS type=Type 2. In this case, for example, in a case where the DMRS type of the PUSCH transmission is Type 1, terminal 200 transmits the PUSCH by switching the transmission waveform to DFT-s-OFDM. On the other hand, in a case where the DMRS type of the PUSCH transmission is Type 2, terminal 200 transmits the PUSCH by applying the transmission waveform (for example, CP-OFDM) that is configured semi-statically by transformPrecoder or msg3-transformPrecoder.

The DMRS type supported by DFT-s-OFDM is not limited to Type 1, and another type may be supported. In addition, the DMRS type is not limited to Type 1 and Type 2, and may include another type.

In addition, terminal 200 may determine the switching of the transmission waveform of the PUSCH based on, for example, the number of additional DMRS symbols in the DMRS configuration of the PUSCH transmission. For example, in a case where the number of additional DMRS symbols is equal to or greater than N (or in a case where the number of additional DMRS symbols is greater than N), terminal 200 transmits the PUSCH by switching the transmission waveform to DFT-s-OFDM. On the other hand, in a case where the number of additional DMRS symbols is less than N (or in a case where the number of additional DMRS symbols is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

The conditions related to the switching of the transmission waveform have been described above.

Terminal 200 may switch the transmission waveform of the PUSCH to DFT-s-OFDM based on, for example, any one of the four conditions described above. For example, terminal 200 may switch the transmission waveform of the PUSCH to DFT-s-OFDM based on Condition 1.

Alternatively, terminal 200 may switch the transmission waveform of the PUSCH to DFT-s-OFDM based on, for example, a plurality of conditions among the four conditions described above.

In a case where a plurality of conditions are used, for example, terminal 200 may switch the transmission waveform to DFT-s-OFDM when any one of the plurality of conditions satisfies the condition for switching the transmission waveform to DFT-s-OFDM. For example, in a case where the condition for switching the transmission waveform to DFT-s-OFDM is not satisfied in all of the plurality of conditions, terminal 200 may transmit the PUSCH by applying the transmission waveform (for example, CP-OFDM) that is configured semi-statically by transformPrecoder or msg3-transformPrecoder.

Alternatively, for example, terminal 200 may switch the transmission waveform to DFT-s-OFDM when the condition for switching the transmission waveform to DFT-s-OFDM is satisfied in all of the plurality of conditions. For example, when any one of the plurality of conditions does not satisfy the condition for switching the transmission waveform to DFT-s-OFDM, terminal 200 may transmit the PUSCH by applying the transmission waveform (for example, CP-OFDM) that is configured semi-statically by transformPrecoder or msg3-transformPrecoder.

In addition, for example, in a case where M (or M or more) conditions among the plurality of conditions satisfy the condition for switching the transmission waveform to DFT-s-OFDM, terminal 200 may switch the transmission waveform to DFT-s-OFDM. Here, a value of M may be provided in advance on the standard, or may be configured (or indicated) to terminal 200 via RRC or another signal.

In addition, for example, terminal 200 may be configured (or indicated) via RRC or another signal regarding which condition (one or a plurality of conditions) among the four conditions described above is used for switching the transmission waveform to DFT-s-OFDM (for example, information related to the condition to be applied).

The operation example in a case where terminal 200 determines the transmission waveform of the Msg.3 PUSCH to be DFT-s-OFDM by ignoring the configuration of Msg.3-transformPrecoder in the determination of the transmission waveform of the Msg.3 PUSCH has been described above.

By contrast, in a case where the transmission waveform of the Msg.3 PUSCH is determined in accordance with the configuration of Msg.3-transformPrecoder, terminal 200 may transmit the PUSCH by applying the transmission waveform that is configured semi-statically by transformPrecoder or Msg.3-transformPrecoder.

According to the present embodiment, in a case where terminal 200 switches the transmission waveform of the Msg.3 PUSCH to DFT-s-OFDM in order to improve the coverage performance in the random access procedure (for example, in a case of the initial access), terminal 200 can continue to dynamically switch the transmission waveform without the overhead of adding a transmission waveform indication field to DCI in an environment in which the improvement of the coverage or the transmission performance is expected even after the random access procedure.

### Operation Example of Terminal 200

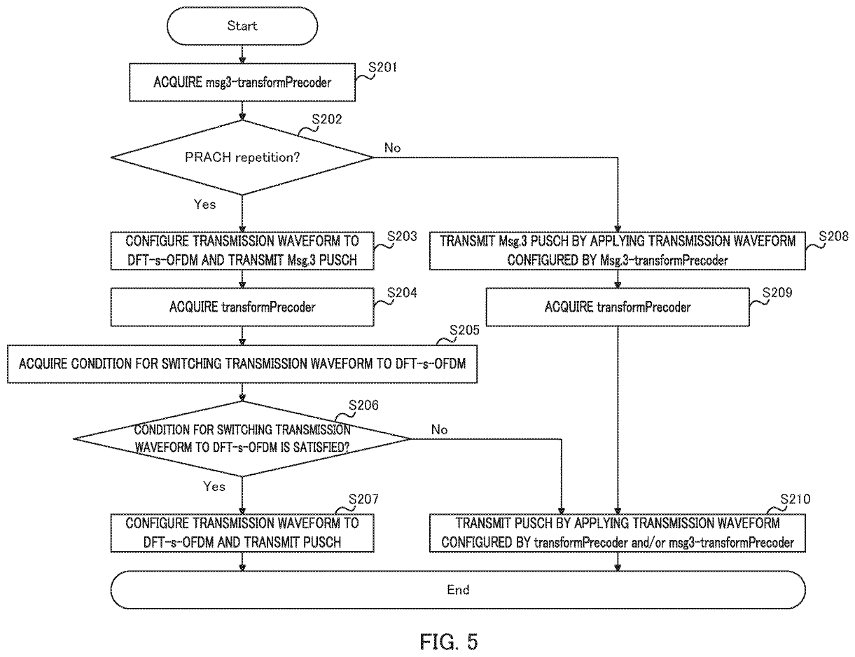

FIG. 5 is a flowchart illustrating an operation example of terminal 200.

In FIG. 5, terminal 200 acquires a higher-layer parameter such as msg3-transformPrecoder (S201).

Terminal 200 determines whether PRACH repetition (or multiple PRACH transmission) is applied (S202).

In a case where PRACH repetition is applied (S202: Yes), terminal 200 configures the transmission waveform of Msg.3 PUSCH to DFT-s-OFDM by ignoring the configuration of Msg.3-transformPrecoder, and transmits the Msg.3 PUSCH (S203).

Terminal 200 acquires transformPrecoder (S204).

Terminal 200 acquires information related to the condition for switching the transmission waveform of PUSCH to DFT-s-OFDM (S205). The information related to the condition for switching the transmission waveform of PUSCH to DFT-s-OFDM may include, for example, information related to the configuration of the condition to be applied among the four conditions described above, or may include information related to the parameters and the configurations (for example, Repetition, the number of layers, an RB configuration, a DMRS configuration, or a threshold) used in the four conditions described above.

Terminal 200 determines whether the condition for switching the transmission waveform of PUSCH to DFT-s-OFDM is satisfied (S206).

In a case where the condition for switching the transmission waveform of PUSCH to DFT-s-OFDM is satisfied (S206: Yes), terminal 200 configures (or switches) the transmission waveform of the PUSCH to DFT-s-OFDM, and transmits the PUSCH (S207).

In a case where PRACH repetition is not applied in the processing of S202 (S202: No), terminal 200 transmits the Msg.3 PUSCH using the transmission waveform configured by Msg.3-transformPrecoder (S208). Terminal 200 then acquires transformPrecoder (S209).

In addition, in a case where PRACH repetition is not applied in the processing of S202 (S202: No) or in a case where the condition for switching the transmission waveform of PUSCH to DFT-s-OFDM is not satisfied in the processing of S206 (S206: No), terminal 200 transmits the PUSCH by applying the transmission waveform (for example, CP-OFDM) configured by at least one of transformPrecoder and/or msg3-transformPrecoder (S210).

As described above, in the present embodiment, in a case where the transmission waveform of the Msg.3 PUSCH is determined to be DFT-s-OFDM by ignoring the configuration of msg3-transformPrecoder, terminal 200 determines the switching of the transmission waveform of the PUSCH transmitted after the Msg.3 PUSCH to DFT-s-OFDM, based on the condition related to the parameter and the configuration of the PUSCH transmission. Accordingly, in a case where the transmission waveform of the Msg.3 PUSCH is switched to DFT-s-OFDM by ignoring the configuration of msg3-transformPrecoder, terminal 200 can dynamically switch the transmission waveform of the PUSCH in response to the instantaneous variations in the channel or interference environment even in the transmission of the PUSCH after the Msg.3 PUSCH, in an environment in which the improvement of the coverage or the transmission performance is expected. Thus, according to the present embodiment, terminal 200 can appropriately transmit a signal in the uplink.

In the present embodiment, a case has been described in which terminal 200 determines whether to switch the transmission waveform to DFT-s-OFDM by ignoring the configuration of the higher-layer parameter for the Msg.3 PUSCH, depending on the presence or absence of the application of multiple PRACH transmission or PRACH repetition, but the determination criterion is not limited to this. For example, in the same manner as in Embodiment 1, terminal 200 may determine, based on the condition related to the parameter or the configuration of the PUSCH transmission, whether to switch the transmission waveform to DFT-s-OFDM by ignoring the configuration of the higher-layer parameter for the Msg.3 PUSCH.

### Variation 2

In Variation 2, for example, the method of Embodiment 2 described above may be applied to the determination of the default transmission waveform.

Here, the determination of the default transmission waveform refers to a case where the transmission waveform is determined based on Msg.3-transformPrecoder as described above. For example, the determination of the default transmission waveform may be at least one of the determination of the transmission waveform of the PUSCH (DG-PUSCH) that is dynamically scheduled by DCI format 0-0, the determination of the transmission waveform of the PUSCH that is dynamically scheduled by DCI format 0-1 or DCI format 0-2 in a case where transformPrecoder is not configured via RRC, and/or the determination of the transmission waveform of the CG-PUSCH in a case where transformPrecoder is not configured via RRC.

In Variation 2, in the same manner as in Embodiment 2, in a case where the PRACH is transmitted by applying multiple PRACH transmission or PRACH repetition, terminal 200 determines the transmission waveform of the Msg.3 PUSCH to be DFT-s-OFDM by ignoring the configuration of Msg.3-transformPrecoder. In this case, terminal 200 that supports the capability of multiple PRACH transmission or PRACH repetition may support, for example, a capability of selecting the transmission waveform without depending on the indication of Msg.3-transformPrecoder. Here, the capability of selecting the transmission waveform without depending on the indication of Msg.3-transformPrecoder may be a capability of dynamically switching the transmission waveform of Msg.3 PUSCH or may be a capability of ignoring the configuration of CP-OFDM by Msg.3-transformPrecoder for Msg.3 PUSCH.

In Variation 2, in a case where terminal 200 determines the transmission waveform of Msg.3 PUSCH to be DFT-s-OFDM by ignoring the configuration of Msg.3-transformPrecoder in the determination of the transmission waveform of the Msg.3 PUSCH, the method of Embodiment 2 described above may be applied to the determination of the default transmission waveform of the PUSCH transmitted after the Msg.3 PUSCH (for example, the transmission waveform of the PUSCH in a case where transformPrecoder is not configured).

Base station 100 (for example, base station/network) semi-statically configures the transmission waveform for terminal 200 by transformPrecoder or Msg.3-transformPrecoder, which is a higher-layer parameter, for example, in the same manner as in NR up to Rel. 17.

For example, terminal 200 may have its semi-static transmission waveform configured to CP-OFDM for the PUSCH that is dynamically scheduled by DCI format 0-0, the PUSCH that is dynamically scheduled by DCI format 0-1 or DCI format 0-2 in a case where transformPrecoder is not configured via RRC, and the CG-PUSCH in a case where transformPrecoder is not configured via RRC.

In Variation 2, in a case where terminal 200 determines the transmission waveform of Msg.3 PUSCH to be DFT-s-OFDM by ignoring the configuration of Msg.3-transformPrecoder in the determination of the transmission waveform of the Msg.3 PUSCH, terminal 200 may transmit PUSCH by switching the transmission waveform of at least one of the PUSCH that is dynamically scheduled by DCI format 0-0, the PUSCH that is dynamically scheduled by DCI format 0-1 or DCI format 0-2 in a case where transformPrecoder is not configured via RRC, and/or the CG-PUSCH in a case where transformPrecoder is not configured via RRC, to DFT-s-OFDM based on any one of the following conditions or a plurality of the following conditions.

### Condition 1: Whether Repetition is Applied or Not or Number of Repetitions

Terminal 200 may determine the switching of the transmission waveform of the PUSCH to DFT-s-OFDM based on, for example, whether repetition is applied or not in the PUSCH transmission. For example, in a case where the repetition is applied to the PUSCH transmission, terminal 200 transmits the PUSCH by switching the transmission waveform to DFT-s-OFDM. On the other hand, in a case where the repetition is not applied to the PUSCH transmission, terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH to DFT-s-OFDM based on, for example, the number of repetitions (the number of times of repetition) of the PUSCH. For example, in a case where the number of repetitions is equal to or greater than N (or in a case where the number of repetitions is greater than N), terminal 200 transmits the PUSCH by switching the transmission waveform to DFT-s-OFDM. On the other hand, in a case where the number of repetitions is less than N (or in a case where the number of repetitions is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 2: Number of Transmission Layers

Terminal 200 may determine the switching of the transmission waveform of the PUSCH to DFT-s-OFDM based on, for example, the number of transmission layers (or the number of ranks) in the PUSCH transmission.

As described above, in the existing NR, DFT-s-OFDM supports single-layer transmission. In this case, for example, in a case where the PUSCH transmission is a single-layer transmission, terminal 200 transmits the PUSCH by switching the transmission waveform to DFT-s-OFDM. On the other hand, in a case where the PUSCH transmission is a multi-layer transmission, terminal 200 transmits the PUSCH by applying the transmission waveform (for example, CP-OFDM) that is configured semi-statically by transformPrecoder or msg3-transformPrecoder.

In addition, for example, in a case where DFT-s-OFDM supports multi-layer transmission, terminal 200 may switch the transmission waveform to DFT-s-OFDM based on the number of transmission layers being one or more. For example, in a case where the number of transmission layers is equal to or less than N (or in a case where the number of transmission layers is less than N), terminal 200 transmits the PUSCH by switching the transmission waveform to DFT-s-OFDM. On the other hand, in a case where the number of transmission layers is greater than N (or in a case where the number of transmission layers is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

### Condition 3: Frequency Domain Resource Allocation Type, Number of Resource Blocks (RBs) allocated in Frequency Domain, or Number of Clustered Resource Blocks

Terminal 200 may determine the switching of the transmission waveform of the PUSCH to DFT-s-OFDM based on, for example, the resource allocation (for example, the frequency resource allocation) in the PUSCH transmission.

Terminal 200 may determine the switching of the transmission waveform of the PUSCH based on, for example, a frequency resource allocation type of the PUSCH transmission. For example, in a case where the frequency resource allocation type of the PUSCH transmission is Type 1 (for example, continuous RB allocation or allocation for which a starting RB and the number of RBs are indicated), terminal 200 transmits the PUSCH by switching the transmission waveform to DFT-s-OFDM. On the other hand, in a case where the PUSCH transmission is Type 0 (for example, non-continuous RB allocation or bitmap allocation by RB/RBG (RB group)), terminal 200 transmits the PUSCH by applying the transmission waveform (for example, CP-OFDM) that is configured semi-statically by transformPrecoder or msg3-transformPrecoder.

In addition, terminal 200 may determine the switching of the transmission waveform of the PUSCH based on, for example, the number of allocated RBs in the frequency domain resource allocation of the PUSCH transmission. For example, in a case where the number of allocated RBs is equal to or less than N (or in a case where the number of allocated RBs is less than N), terminal 200 transmits the PUSCH by switching the transmission waveform to DFT-s-OFDM. On the other hand, in a case where the number of allocated RBs is greater than N (or in a case where the number of allocated RBs is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) to terminal 200 via RRC or another signal.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of RBs constituting the cluster.

For example, in a case where the number of RBs constituting the cluster is equal to or less than N (or in a case where the number of RBs constituting the cluster is less than N), terminal 200 transmits the PUSCH by switching the transmission waveform to DFT-s-OFDM. On the other hand, in a case where the number of RBs constituting the cluster is greater than N (or in a case where the number of RBs constituting the cluster is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

In addition, the cluster used for determining the switching of the transmission waveform may be a cluster having the maximum number of RBs or a cluster having the minimum number of RBs. In addition, the cluster used for determining the switching of the transmission waveform may be a cluster having a specific index.

In addition, for example, in a case where DFT-s-OFDM supports Clustered DFT-s-OFDM in which a plurality of clusters composed of continuous RBs can be allocated, terminal 200 may determine the switching of the transmission waveform of the PUSCH based on, for example, the number of clusters.

For example, in a case where the number of clusters is equal to or less than N (or in a case where the number of clusters is less than N), terminal 200 transmits the PUSCH by switching the transmission waveform to DFT-s-OFDM. On the other hand, in a case where the number of clusters is greater than N (or in a case where the number of clusters is equal to or greater than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

### Condition 4: DMRS Type or Number of Additional DMRS Symbols

Terminal 200 may determine the switching of the transmission waveform of the PUSCH to DFT-s-OFDM based on, for example, the DMRS configuration in the PUSCH transmission.

Terminal 200 may determine the switching of the transmission waveform of the PUSCH based on, for example, the DMRS type in the PUSCH transmission. For example, in the existing NR, DFT-s-OFDM supports DMRS type=Type 1 and does not support DMRS type=Type 2. In this case, for example, in a case where the DMRS type of the PUSCH transmission is Type 1, terminal 200 transmits the PUSCH by switching the transmission waveform to DFT-s-OFDM. On the other hand, in a case where the DMRS type of the PUSCH transmission is Type 2, terminal 200 transmits the PUSCH by applying the transmission waveform (for example, CP-OFDM) that is configured semi-statically by transformPrecoder or msg3-transformPrecoder.

The DMRS type supported by DFT-s-OFDM is not limited to Type 1, and another type may be supported. In addition, the DMRS type is not limited to Type 1 and Type 2, and may include another type.

In addition, terminal 200 may determine the switching of the transmission waveform of the PUSCH based on, for example, the number of additional DMRS symbols in the DMRS configuration of the PUSCH transmission.

For example, in a case where the number of additional DMRS symbols is equal to or greater than N (or in a case where the number of additional DMRS symbols is greater than N), terminal 200 transmits the PUSCH by switching the transmission waveform to DFT-s-OFDM. On the other hand, in a case where the number of additional DMRS symbols is smaller than N (or in a case where the number of additional DMRS symbols is equal to or less than N), terminal 200 transmits the PUSCH by applying the transmission waveform (for example, CP-OFDM) that is configured semi-statically by transformPrecoder or msg3-transformPrecoder.

Here, a value of threshold N may be provided in advance on the standard, or may be configured (or indicated) via RRC or another signal.

The conditions related to the switching of the transmission waveform have been described above.

Terminal 200 may switch the transmission waveform of the PUSCH to DFT-s-OFDM based on, for example, any one of the four conditions described above. For example, terminal 200 may switch the transmission waveform of the PUSCH to DFT-s-OFDM based on Condition 1.

Alternatively, terminal 200 may switch the transmission waveform of the PUSCH to DFT-s-OFDM based on, for example, a plurality of conditions among the four conditions described above.

In a case where the plurality of conditions are used, for example, terminal 200 may switch the transmission waveform to DFT-s-OFDM when any one of the plurality of conditions satisfies the condition for switching the transmission waveform to DFT-s-OFDM. For example, when the condition for switching the transmission waveform to DFT-s-OFDM is not satisfied in all of the plurality of conditions, terminal 200 may transmit the PUSCH by applying the transmission waveform (for example, CP-OFDM) that is configured semi-statically by transformPrecoder or msg3-transformPrecoder.

Alternatively, for example, terminal 200 may switch the transmission waveform to DFT-s-OFDM when the condition for switching the transmission waveform to DFT-s-OFDM is satisfied in all of the plurality of conditions. For example, when any one of the plurality of conditions does not satisfy the condition for switching the transmission waveform to DFT-s-OFDM, terminal 200 may transmit the PUSCH by applying the transmission waveform (for example, CP-OFDM) that is configured semi-statically by transformPrecoder or msg3-transformPrecoder.

In addition, for example, in a case where M (or M or more) conditions among the plurality of conditions satisfy the condition for switching the transmission waveform to DFT-s-OFDM, terminal 200 may switch the transmission waveform to DFT-s-OFDM. Here, a value of M may be provided in advance on the standard, or may be configured (or indicated) to terminal 200 via RRC or another signal.

In addition, for example, terminal 200 may be configured (or indicated) via RRC or another signal regarding which condition (one or a plurality of conditions) among the four conditions described above is used for switching the transmission waveform to DFT-s-OFDM (for example, information related to the condition to be applied).

The method of determining the default transmission waveform in a case where terminal 200 determines the transmission waveform of the Msg.3 PUSCH to be DFT-s-OFDM by ignoring the configuration of Msg.3-transformPrecoder in the determination of the transmission waveform of the Msg.3 PUSCH has been described above.

By contrast, in a case where the transmission waveform of the Msg.3 PUSCH is determined in accordance with the configuration of Msg.3-transformPrecoder, terminal 200 may transmit the PUSCH by applying the transmission waveform that is configured semi-statically by transformPrecoder or Msg.3-transformPrecoder. In addition, terminal 200 transmits the PUSCH by applying the transmission waveform that is configured semi-statically by transformPrecoder to the transmission waveform of the PUSCH that is dynamically scheduled by DCI format 0-1 or DCI format 0-2 in a case where transformPrecoder is configured, and the transmission waveform of the CG-PUSCH.

According to Variation 2, in a case where terminal 200 switches the transmission waveform of the Msg.3 PUSCH to DFT-s-OFDM in order to improve the coverage performance in the random access procedure (for example, in a case of the initial access), terminal 200 can continue, even after the random access procedure, to dynamically switch the transmission waveform of the PUSCH that can be determined based on Msg.3-transformPrecoder, which is cell-specific RRC, without the overhead of adding a transmission waveform indication field to DCI in an environment in which the improvement of the coverage or the transmission performance is expected.

Note that, in the determination of the transmission waveform of Msg.3 PUSCH, in a case where terminal 200 determines the transmission waveform of the Msg.3 PUSCH to be DFT-s-OFDM by ignoring the configuration of Msg.3-transformPrecoder, terminal 200 may determine at least one (for example, the default transmission waveform) of the transmission waveform of the PUSCH that is dynamically scheduled by DCI format 0-0, the transmission waveform of the PUSCH that is dynamically scheduled by DCI format 0-1 or DCI format 0-2 in a case where transformPrecoder is not configured via RRC, and/or the transmission waveform of the CG-PUSCH in a case where transformPrecoder is not configured via RRC, in accordance with any one of the following methods (Option 1 or Option 2).

### Option 1

In Option 1, in a case where terminal 200 determines the transmission waveform of Msg.3 PUSCH to be DFT-s-OFDM by ignoring the configuration of Msg.3-transformPrecoder in the determination of the transmission waveform of the Msg.3 PUSCH, terminal 200 determines at least one of the transmission waveform of the PUSCH that is dynamically scheduled by DCI format 0-0, the transmission waveform of the PUSCH that is dynamically scheduled by DCI format 0-1 or DCI format 0-2 in a case where transformPrecoder is not configured via RRC, and/or the transmission waveform of the CG-PUSCH in a case where transformPrecoder is not configured via RRC, to be the same as the transmission waveform configured by Msg.3-transformPrecoder.

In addition, in a case where terminal 200 determines the transmission waveform of the Msg.3 PUSCH in accordance with the configuration of Msg.3-transformPrecoder, terminal 200 may configure the transmission waveform that is configured semi-statically by Msg.3-transformPrecoder as the default transmission waveform, and transmit PUSCH.

### Option 2

In Option 2, in a case where terminal 200 determines the transmission waveform of Msg.3 PUSCH to be DFT-s-OFDM by ignoring the configuration of Msg.3-transformPrecoder in the determination of the transmission waveform of the Msg.3 PUSCH, terminal 200 determines at least one of the transmission waveform of the PUSCH that is dynamically scheduled by DCI format 0-0, the transmission waveform of the PUSCH that is dynamically scheduled by DCI format 0-1 or DCI format 0-2 in a case where transformPrecoder is not configured via RRC, and/or the transmission waveform of the CG-PUSCH in a case where transformPrecoder is not configured via RRC, to be the same as the transmission waveform applied to the Msg.3.

On the other hand, in a case where terminal 200 determines the transmission waveform of the Msg.3 PUSCH in accordance with the configuration of Msg.3-transformPrecoder, terminal 200 may configure the transmission waveform that is configured semi-statically by Msg.3-transformPrecoder as the default transmission waveform, and transmit the PUSCH.

### Configuration of Base Station

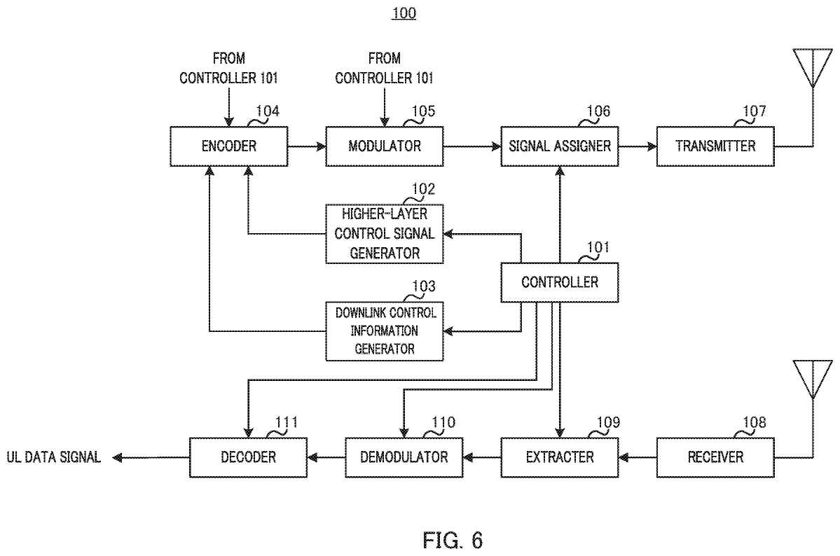

FIG. 6 is a block diagram illustrating a configuration example of base station 100 according to Embodiment 1. In FIG. 6, base station 100 includes controller 101, higher-layer control signal generator 102, downlink control information generator 103, encoder 104, modulator 105, signal assigner 106, transmitter 107, receiver 108, extractor 109, demodulator 110, and decoder 111.

Note that, at least one of controller 101, higher-layer control signal generator 102, downlink control information generator 103, encoder 104, modulator 105, signal assigner 106, extractor 109, demodulator 110, and decoder 111 illustrated in FIG. 6 may be included in the controller illustrated in FIG. 2. Furthermore, receiver 108 illustrated in FIG. 6 may be included in the receiver illustrated in FIG. 2.

For example, controller 101 determines information related to uplink transmission (for example, PUSCH transmission) for terminal 200, and outputs the determined information to at least one of higher-layer control signal generator 102 or downlink control information generator 103. The information related to the PUSCH transmission may include, for example, information related to a transmission waveform (for example, transformPrecoder, msg3-transformPrecoder, or information related to the condition for switching the transmission waveform to DFT-s-OFDM), time domain resource allocation information (for example, Time Domain Resource Allocation (TDRA) or Repetition), information related to the number of transmission layers, frequency domain resource allocation information (for example, Frequency Domain Resource Allocation (FDRA)), or information related to a DMRS configuration. Further, controller 101 outputs the determined information to extractor 109, demodulator 110, and decoder 111.

Controller 101 also determines, for example, information on a downlink signal for transmitting a higher-layer control signal or downlink control information (e.g., modulation and coding scheme (MCS) and radio resource allocation), and outputs the determined information to encoder 104, modulator 105, and signal assigner 106. Further, controller 101 outputs the information on the downlink signal (e.g., data signal or higher-layer control signal) to downlink control information generator 103, for example.

Higher-layer control signal generator 102 generates a higher-layer control signal bit sequence, for example, based on the information input from controller 101, and outputs the higher-layer control signal bit sequence to encoder 104.

Downlink control information generator 103 generates a downlink control information (e.g., DCI) bit sequence, for example, based on the information input from controller 101, and outputs the generated DCI bit sequence to encoder 104. Note that the control information may be sometimes transmitted to a plurality of terminals.

Encoder 104 encodes, for example, the bit sequence input from higher-layer control signal generator 102, or the DCI bit sequence input from downlink control information generator 103 based on the information input from controller 101. Encoder 104 outputs the encoded bit sequence to modulator 105.

Modulator 105 modulates the encoded bit sequence input from encoder 104, for example, based on the information input from controller 101, and outputs the modulated signal (e.g., symbol sequence) to signal assigner 106.

Signal assigner 106 maps the symbol sequence (e.g., including downlink data signal or control signal) input from modulator 105 to a radio resource based on the information indicating the radio resource input from controller 101, for example. Signal assigner 106 outputs the mapped downlink signal to transmitter 107.

Transmitter 107 performs, for example, transmission waveform generation processing such as orthogonal frequency division multiplexing (OFDM), on the signal input from signal assigner 106. Further, for example, in the case of an OFDM transmission in which a cyclic prefix (CP) is added, transmitter 107 performs Inverse Fast Fourier Transform (IFFT) processing on the signal, and adds a CP to the signal after the IFFT. Further, transmitter 107 performs, for example, RF processing such as D/A conversion or up-conversion on the signal, and transmits a radio signal to terminal 200 via an antenna.

Receiver 108, for example, performs RF processing such as down-conversion or A/D conversion on an uplink signal received from terminal 200 via an antenna. Further, in the case of an OFDM transmission, receiver 108 performs Fast Fourier Transform (FFT) processing on the received signal, for example, and outputs the obtained frequency-domain signal to extractor 109.

Extractor 109 extracts, for example, a radio resource portion on which an uplink signal (e.g., PUSCH) has been transmitted, from the received signal input from receiver 108, based on the information input from controller 101, and then outputs the extracted radio resource portion to demodulator 110.

Demodulator 110 demodulates the uplink signal (e.g., PUSCH) input from extractor 109 based on the information input from controller 101, for example. Demodulator 110 outputs, for example, the demodulation result to decoder 111.

Decoder 111 performs error correction decoding on the uplink signal (e.g., PUSCH) based on the information input from controller 101 and the demodulation result input from demodulator 110, and obtains a decoded reception bit sequence.

### Configuration of Terminal

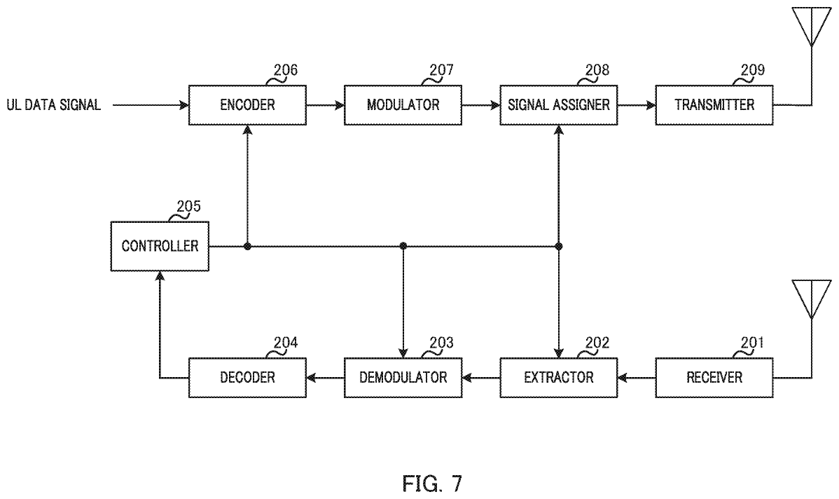

FIG. 7 is a block diagram illustrating an exemplary configuration of terminal 200 according to an exemplary embodiment of the present disclosure. For example, in FIG. 7, terminal 200 includes receiver 201, extractor 202, demodulator 203, decoder 204, controller 205, encoder 206, modulator 207, signal assigner 208, and transmitter 209.

Note that, at least one of extractor 202, demodulator 203, decoder 204, controller 205, encoder 206, modulator 207, and signal assigner 208 illustrated in FIG. 7 may be included in the controller illustrated in FIG. 3. Furthermore, transmitter 209 illustrated in FIG. 7 may be included in the transmitter illustrated in FIG. 3.

Receiver 201 receives a downlink signal (e.g., downlink data signal or downlink control information) from base station 100 via an antenna, performs RF processing such as down-conversion or A/D conversion on the received radio signal, and obtains a received signal (baseband signal). Further, when receiver 201 receives an OFDM signal, receiver 201 performs FFT processing on the received signal and converts the received signal into the frequency domain. Receiver 201 outputs the received signal to extractor 202.

Extractor 202 extracts, for example, a radio resource portion which may include downlink control information, from the received signal input from receiver 201, based on information on the radio resource of downlink control information, which is input from controller 205, and then outputs the radio resource portion to demodulator 203. Further, extractor 202 extracts a radio resource portion including a downlink data signal, based on information on the radio resource of a data signal input from controller 205, and outputs the radio resource portion to demodulator 203.

Demodulator 203 demodulates, for example, based on information input from controller 205, the signals input from extractor 202 (e.g., PDCCH or PDSCH), and outputs the demodulation result to decoder 204.

Decoder 204 performs, for example, error correction decoding of PDCCH or PDSCH using the demodulation result input from demodulator 203, and obtains, for example, a higher-layer control signal or downlink control information. Decoder 204 outputs the higher-layer control signal and the downlink control information to controller 205. Further, decoder 204 may generate a response signal (e.g., ACK/NACK) based on the decoding result of the PDSCH.

For example, controller 205 performs uplink transmission control (for example, including the determination of the transmission waveform for the PUSCH transmission) in accordance with the above-described method based on the information related to the PUSCH transmission obtained from the signal (for example, higher-layer control signal or downlink control information) input from decoder 204. Controller 205 outputs the determined information to, for example, encoder 206 and signal assigner 208.

Encoder 206 encodes an uplink data signal (UL data signal) or an uplink control signal based on the information input from controller 205, for example. Encoder 206 outputs the encoded bit sequence to modulator 207.

Modulator 207 modulates, for example, the encoded bit sequence input from encoder 206, and outputs the modulated signal (symbol sequence) to signal assigner 208.

Signal assigner 208 maps the signal (e.g., sequence) input from modulator 207 to a radio resource, for example, based on the information input from controller 205. Signal assigner 208 outputs the mapped uplink signal to transmitter 209, for example.

Transmitter 209 performs generation of a transmission signal waveform, such as OFDM, on the signal input from signal assigner 208. Further, in the case of an OFDM transmission using a CP, for example, transmitter 209 performs IFFT processing on the signal and adds a CP to the signal after the IFFT. Alternatively, when transmitter 209 generates a single carrier waveform, a DFT processor may be added downstream of modulator 207 or upstream of signal assigner 208 (not illustrated), for example. Further, transmitter 209 performs, for example, RF processing such as D/A conversion and up-conversion on the transmission signal, and transmits the radio signal to base station 100 via an antenna.

### Other Embodiments

(1) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied depending on the type of the PUSCH transmission. In addition, even in a case where one embodiment and variation are applied, the condition for switching the transmission waveform to DFT-s-OFDM may be applied depending on the type of the PUSCH transmission.

For example, examples of the type of the PUSCH transmission include the PUSCH that is dynamically scheduled by DCI format 0-0, the PUSCH that is dynamically scheduled by DCI format 0-1 or DCI format 0-2 in a case where transformPrecoder is configured via RRC, the PUSCH that is dynamically scheduled by DCI format 0-1 or DCI format 0-2 in a case where transformPrecoder is not configured via RRC, the CG-PUSCH in a case where transformPrecoder is configured via RRC, and the CG-PUSCH in a case where transformPrecoder is not configured via RRC.

For example, the semi-static transmission waveform determination method similar to the existing NR may be applied to the PUSCH that is dynamically scheduled by DCI format 0-0. In addition, for example, the above-described embodiments, variations, or other transmission waveform determination methods may be applied to the PUSCH that is dynamically scheduled by DCI format 0-1 or DCI format 0-2 in a case where transformPrecoder is not configured via RRC.

(2) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied differently between Terrestrial networks (TN) and non-Terrestrial networks (NTN).

For example, the above-described embodiments, variations, or other transmission waveform determination methods may be applied to the NTN for which the coverage enhancement is expected, and the semi-static transmission waveform determination method similar to the existing NR may be applied to the TN.

In addition, for example, the above-described embodiments, variations, or other transmission waveform determination methods may be applied to both the TN and the NTN, and the condition for switching the transmission waveform to DFT-s-OFDM may be varied between the TN and the NTN. For example, the number of conditions for switching the transmission waveform to DFT-s-OFDM (for example, the number of conditions to be applied among the four conditions described above or the value of M described above) may be varied between the TN and the NTN.

(3) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied differently depending on the frequency range.

For example, the above-described embodiments, variations, or other transmission waveform determination methods may be applied to FR2 for which the coverage enhancement is expected, and the semi-static transmission waveform determination methods similar to the existing NR may be applied to FR1.

In addition, for example, the above-described embodiments, variations, or other transmission waveform determination methods may be applied to both FR1 and FR2, and the condition for switching the transmission waveform to DFT-s-OFDM may be varied between FR1 and FR2. For example, the number of conditions for switching the transmission waveform to DFT-s-OFDM (for example, the number of conditions to be applied among the four conditions described above or the value of M described above) may be varied between FR1 and FR2.

(4) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied differently between communication between a base station and a terminal (Uu) and communication between terminals (Sidelink communication).

For example, the above-described embodiments, variations, or other transmission waveform determination methods may be applied to the Uu for which the coverage enhancement is expected, and the semi-static transmission waveform determination methods similar to the existing NR may be applied to the Sidelink.

In addition, for example, the above-described embodiments, variations, or other transmission waveform determination methods may be applied to both the Uu and the Sidelink, and the condition for switching the transmission waveform to DFT-s-OFDM may be varied between the Uu and the Sidelink. For example, the number of conditions for switching the transmission waveform to DFT-s-OFDM (for example, the number of conditions to be applied among the four conditions described above or the value of M described above) may be varied between the Uu and the Sidelink.

(5) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied differently between licensed band operation and unlicensed band operation.

For example, the above-described embodiments, variations, or other transmission waveform determination methods may be applied to both the licensed band and the unlicensed band, and the condition for switching the transmission waveform to DFT-s-OFDM may be varied between the licensed band and the unlicensed band. For example, the number of conditions for switching the transmission waveform to DFT-s-OFDM (for example, the number of conditions to be applied among the four conditions described above or the value of M described above) may be varied between the licensed band and the unlicensed band.

(6) The above-described embodiments, variations, other transmission waveform determination methods, and the semi-static transmission waveform determination method (for example, method of transmitting PUSCH by applying the transmission waveform that is configured semi-statically by transformPrecoder or msg3-transformPrecoder) similar to the existing NR may be applied differently between a terminal that achieves low cost, such as a reduced capability terminal (RedCap), and a normal terminal.

For example, the above-described embodiments, variations, or other transmission waveform determination methods may be applied to both the RedCap terminal and the normal terminal, and the condition for switching the transmission waveform to DFT-s-OFDM may be varied between the RedCap terminal and the normal terminal. For example, the number of conditions for switching the transmission waveform to DFT-s-OFDM (for example, the number of conditions to be applied among the four conditions described above or the value of M described above) may be varied between the RedCap terminal and the normal terminal.

(7) The above-described embodiments, variations, and other transmission waveform determination methods are not limited to the switching of the transmission waveform from CP-OFDM to DFT-s-OFDM. For example, in a case where a transmission waveform having better coverage performance than DFT-s-OFDM is adopted, the “CP-OFDM” in the above-described embodiments, variations, and other transmission waveform determination methods may be replaced with the “DFT-s-OFDM,” and the “DFT-s-OFDM” in the above-described embodiments, variations, and other transmission waveform determination methods may be replaced with the transmission waveform having better coverage performance than DFT-s-OFDM.

In addition, in each of the above-described embodiments, the transmission waveform is not limited to two types of DFT-s-OFDM and CP-OFDM, and may be another type of transmission waveform, and the number of types of transmission waveforms that can be applied may be three or more.

(8) In each of the embodiments described above, the channel used for uplink transmission is not limited to PUSCH, and may be another channel. Further, the type of information to be transmitted is not limited to data, and may be information of another type (e.g., uplink control signal). Further, an exemplary embodiment of the present disclosure is not limited to uplink transmission, and may be applied to downlink transmission or sidelink transmission.

The present disclosure may be applied to, for example, communication between terminals, such as sidelink communication.

Further, in the present disclosure, a downlink control channel, a downlink data channel, an uplink control channel, and an uplink data channel are not limited to PDCCH, PDSCH, PUCCH, and PUSCH, respectively, and may be control channels having other names.

Further, in the present disclosure, the RRC signaling is assumed for the higher-layer signaling, but the signaling may be replaced with Medium Access Control (MAC) signaling and indication by a DCI that is physical layer signaling.

### Complement

Information indicating whether terminal 200 supports the functions, operations, or pieces of processing that have been indicated in the above-mentioned embodiments and complements may be transmitted (or indicated) from terminal 200 to base station 100, as capability information or a capability parameter for terminal 200, for example.

The capability information may include information elements (IEs) that individually indicate whether terminal 200 supports at least one of the functions, operations, or pieces of processing that have been described in the above-mentioned embodiments, variations, and complements. Alternatively, the capability information may include information elements that indicate whether terminal 200 supports a combination of any two or more of the functions, operations, or pieces of processing that have been described in the above-mentioned embodiments, variations, and complements.

Base station 100 may determine (or decide or assume), for example, based on the capability information received from terminal 200, the functions, operations, or pieces of processing that are supported (or not supported) by terminal 200, which is a transmission source of the capability information. Base station 100 may execute operations, processes, or control in accordance with the determination result based on the capability information. For example, base station 100 may control uplink-related processing based on the capability information received from terminal 200.

Note that, in a case where terminal 200 does not entirely support the functions, operations, or pieces of processing described in the above-mentioned embodiments, variations, and complements, such an unsupported part of the functions, operations, or processes may be interpreted as a limitation in terminal 200. For example, information or a request relating to such a limitation may be indicated to base station 100.

The information on the capability or the limitation of terminal 200 may be defined by standards or may be implicitly indicated to base station 100 in association with information known in base station 100 or information to be transmitted to base station 100, for example.

The embodiments, the variations, and the complements according to a non-limiting and exemplary embodiment of the present disclosure have been each described, thus far.

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or RRC. Further, the uplink control signal may be a pre-defined signal (information). The uplink control signal may be replaced with uplink control information (UCI), the 1st stage sidelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, the base station may be replaced with a terminal. The base station may be a relay apparatus that relays communication between a higher node and a terminal. The base station may be a roadside unit as well.

### Uplink/Downlink/Sidelink

The present disclosure may be applied to any of uplink, downlink and sidelink. The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a terminal and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, a time resource unit is not limited to one or a combination of a slot and a symbol, and may be a time resource unit such as a frame, a superframe, a subframe, a slot, a time slot, a subslot, a minislot, or a time resource unit such as a symbol, an Orthogonal Frequency Division Multiplexing Access (OFDM) symbol, a Single Carrier-Frequency Division Multiple Access (SC-FDMA) symbol, or another time resource unit. The number of symbols included in one slot is not limited to any number of symbols exemplified in the embodiment(s) described above, and may be another number of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### 5G NR System Architecture and Protocol Stack

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

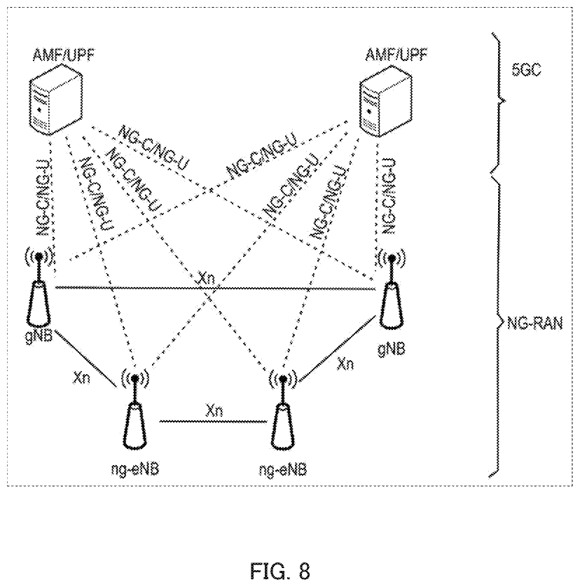

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 8 (see e.g., 3GPP TS 38.300 v15.6.0 , section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0 ).

### Functional Split between NG-RAN and 5GC in 5G NR

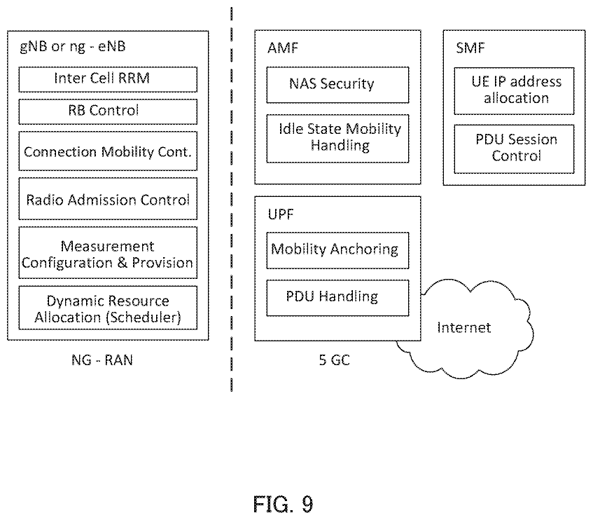

FIG. 9 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating, UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### RRC Connection Setup and Reconfiguration Procedure

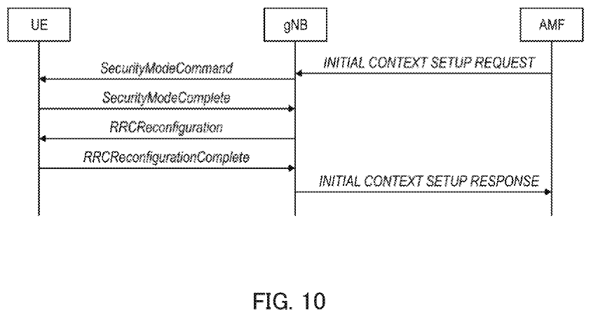

FIG. 10 illustrates some interactions between a UE, gNB, and AMF (a 5GC Entity) performed in the context of a transition of the UE from RRC_IDLE to RRC_CONNECTED for the NAS part (see TS 38 300 v15.6.0).

RRC is higher-layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### Usage Scenarios of IMT for 2020 and beyond

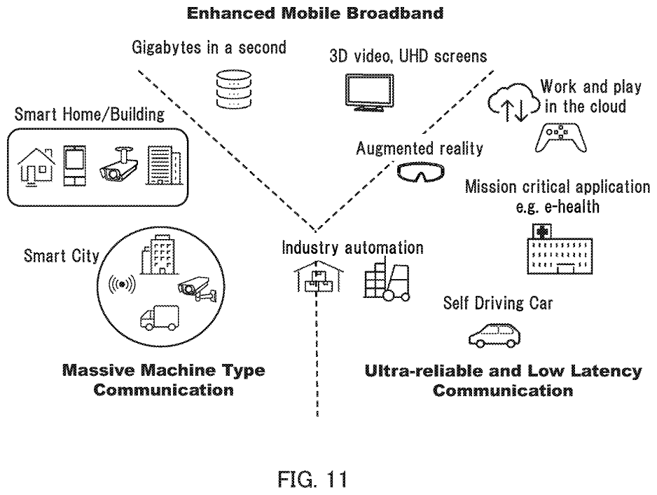

FIG. 11 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 11 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10-6 level), higher availability, packet sizes of up to 256 bytes, time synchronization up to the extent of a few us (where the value can be one or a few μs depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 10. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

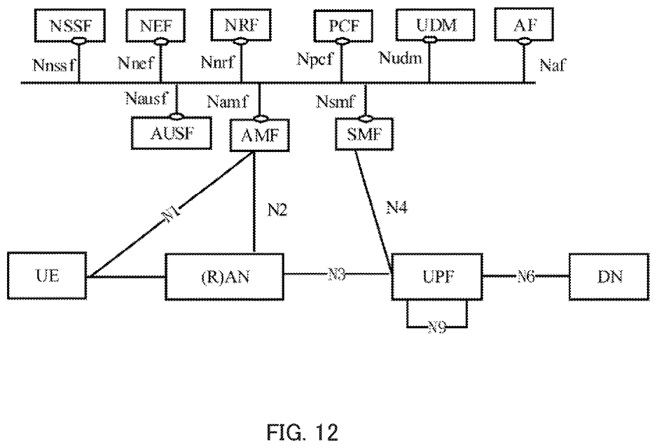

FIG. 12 illustrates a 5G NR non-roaming reference architecture (see TS 23.501 v16.1.0, section 4.23). An Application Function (AF) (e.g., an external application server hosting 5G services, exemplarily described in FIG. 11) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 12 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or third party services). All of or a part of the core network functions and the application services may be deployed and running in cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

In the description of the present disclosure, the term ending with a suffix, such as “-er” “-or” or “-ar” may be interchangeably replaced with another term, such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smartphone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A terminal according to an embodiment of the present disclosure includes: control circuitry, which, in operation, switches a transmission waveform of an uplink signal to a first transmission waveform in a case where a condition related to a parameter and a configuration of transmission of the uplink signal is satisfied; and transmission circuitry, which, in operation, transmits the uplink signal using the first transmission waveform.

In the embodiment of the present disclosure, the parameter and the configuration include at least one of information related to repetition transmission of the uplink signal, information related to a number of transmission layers of the uplink signal, information related to frequency domain resource allocation for the uplink signal, and/or information related to a configuration of a demodulation reference signal for the uplink signal.

In the embodiment of the present disclosure, the control circuitry determines the switching to the first transmission waveform in a case where the repetition transmission is applied to the uplink signal.

In the embodiment of the present disclosure, the control circuitry determines the switching to the first transmission waveform in a case where a number of times of the repetition transmission of the uplink signal is equal to or greater than a threshold.

In the embodiment of the present disclosure, the control circuitry determines the switching to the first transmission waveform in a case where the transmission of the uplink signal is a one-layer transmission.

In the embodiment of the present disclosure, the control circuitry determines the switching to the first transmission waveform in a case where the number of the transmission layers of the uplink signal is equal to or less than a threshold.

In the embodiment of the present disclosure, the control circuitry determines the switching to the first transmission waveform in a case where a type of the frequency domain resource allocation for the uplink signal is a continuous resource-block allocation.

In the embodiment of the present disclosure, the control circuitry determines the switching to the first transmission waveform in a case where a number of allocated resource blocks in the frequency domain resource allocation for the uplink signal is equal to or less than a threshold.

In the embodiment of the present disclosure, the control circuitry determines the switching to the first transmission waveform in a case where a type of the configuration of the demodulation reference signal for the uplink signal is a defined type.

In the embodiment of the present disclosure, the control circuitry determines the switching to the first transmission waveform in a case where a number of additional demodulation reference signal symbols in the configuration of the demodulation reference signal for the uplink signal is equal to or greater than a threshold.

In the embodiment of the present disclosure, the control circuitry determines, based on the condition, the switching to the first transmission waveform, in a case where the transmission waveform of the uplink signal is configured to be a second transmission waveform by a higher-layer parameter.

In the embodiment of the present disclosure, the control circuitry determines, based on the condition, the switching to the first transmission waveform, in a case where a first higher-layer parameter is configured and a second higher-layer parameter is not configured, and the control circuitry determines the transmission waveform based on the second higher-layer parameter, in a case where the second higher-layer parameter is configured.

In the embodiment of the present disclosure, the uplink signal includes a first signal in a random access procedure and a second signal after the random access procedure, and the control circuitry determines, based on the condition, the switching to the first transmission waveform for the second signal, in a case where the transmission waveform of the first signal is determined to be the first transmission waveform by ignoring a configuration of a first higher-layer parameter.

In the embodiment of the present disclosure, the control circuitry determines, based on the condition, the switching to the first transmission waveform for the second signal, in a case where the transmission waveform of the first signal is configured to be the first transmission waveform by ignoring the configuration of the first higher-layer parameter, and a second higher-layer parameter is not configured.

A base station according to an embodiment of the present disclosure includes: control circuitry, which, in operation, switches a transmission waveform of an uplink signal to a first transmission waveform in a case where a condition related to a parameter and a configuration of transmission of the uplink signal is satisfied; and reception circuitry, which, in operation, receives the uplink signal using the first transmission waveform.

In a communication method according to an embodiment of the present disclosure, a terminal switches a transmission waveform of an uplink signal to a first transmission waveform in a case where a condition related to a parameter and a configuration of transmission of the uplink signal is satisfied, and transmits the uplink signal using the first transmission waveform.

In a communication method according to an embodiment of the present disclosure, a base station switches a transmission waveform of an uplink signal to a first transmission waveform in a case where a condition related to a parameter and a configuration of transmission of the uplink signal is satisfied, and receives the uplink signal using the first transmission waveform.

### INDUSTRIAL APPLICABILITY

An exemplary embodiment of the present disclosure is useful for radio communication systems.

### REFERENCE SIGNS LIST

100 Base station
101, 205 Controller
102 Higher-layer control signal generator
103 Downlink control information generator
104, 206 Encoder
105, 207 Modulator
106, 208 Signal assigner
107, 209 Transmitter
108, 201 Receiver
109, 202 Extractor
110, 203 Demodulator
111, 204 Decoder
200 Terminal

1. A terminal, comprising:
control circuitry, which, in operation, switches a transmission waveform of an uplink signal to a first transmission waveform in a case where a condition related to a parameter and a configuration of transmission of the uplink signal is satisfied; and
transmission circuitry, which, in operation, transmits the uplink signal using the first transmission waveform.

2. The terminal according to claim 1, wherein
the parameter and the configuration include at least one of information related to repetition transmission of the uplink signal, information related to a number of transmission layers of the uplink signal, information related to frequency domain resource allocation for the uplink signal, and/or information related to a configuration of a demodulation reference signal for the uplink signal.

3. The terminal according to claim 2, wherein
the control circuitry determines the switching to the first transmission waveform in a case where the repetition transmission is applied to the uplink signal.

4. The terminal according to claim 2, wherein
the control circuitry determines the switching to the first transmission waveform in a case where a number of times of the repetition transmission of the uplink signal is equal to or greater than a threshold.

5. The terminal according to claim 2, wherein
the control circuitry determines the switching to the first transmission waveform in a case where the transmission of the uplink signal is a one-layer transmission.

6. The terminal according to claim 2, wherein
the control circuitry determines the switching to the first transmission waveform in a case where the number of the transmission layers of the uplink signal is equal to or less than a threshold.

7. The terminal according to claim 2, wherein
the control circuitry determines the switching to the first transmission waveform in a case where a type of the frequency domain resource allocation for the uplink signal is a continuous resource-block allocation.

8. The terminal according to claim 2, wherein
the control circuitry determines the switching to the first transmission waveform in a case where a number of allocated resource blocks in the frequency domain resource allocation for the uplink signal is equal to or less than a threshold.

9. The terminal according to claim 2, wherein
the control circuitry determines the switching to the first transmission waveform in a case where a type of the configuration of the demodulation reference signal for the uplink signal is a defined type.

10. The terminal according to claim 2, wherein
the control circuitry determines the switching to the first transmission waveform in a case where a number of additional demodulation reference signal symbols in the configuration of the demodulation reference signal for the uplink signal is equal to or greater than a threshold.

11. The terminal according to claim 1, wherein
the control circuitry determines, based on the condition, the switching to the first transmission waveform, in a case where the transmission waveform of the uplink signal is configured to be a second transmission waveform by a higher-layer parameter.

12. The terminal according to claim 11, wherein
the control circuitry determines, based on the condition, the switching to the first transmission waveform, in a case where a first higher-layer parameter is configured and a second higher-layer parameter is not configured, and
the control circuitry determines the transmission waveform based on the second higher-layer parameter, in a case where the second higher-layer parameter is configured.

13. The terminal according to claim 1, wherein
the uplink signal includes a first signal in a random access procedure and a second signal after the random access procedure, and
the control circuitry determines, based on the condition, the switching to the first transmission waveform for the second signal, in a case where the transmission waveform of the first signal is determined to be the first transmission waveform by ignoring a configuration of a first higher-layer parameter.

14. The terminal according to claim 13, wherein
the control circuitry determines, based on the condition, the switching to the first transmission waveform for the second signal, in a case where the transmission waveform of the first signal is configured to be the first transmission waveform by ignoring the configuration of the first higher-layer parameter, and a second higher-layer parameter is not configured.

15. A base station, comprising:
control circuitry, which, in operation, switches a transmission waveform of an uplink signal to a first transmission waveform in a case where a condition related to a parameter and a configuration of transmission of the uplink signal is satisfied; and
reception circuitry, which, in operation, receives the uplink signal using the first transmission waveform.

16. A communication method, comprising:
switching, by a terminal, a transmission waveform of an uplink signal to a first transmission waveform in a case where a condition related to a parameter and a configuration of transmission of the uplink signal is satisfied; and
transmitting, by the terminal, the uplink signal using the first transmission waveform.

17. A communication method, comprising:
switching, by a base station, a transmission waveform of an uplink signal to a first transmission waveform in a case where a condition related to a parameter and a configuration of transmission of the uplink signal is satisfied; and
receiving, by the base station, the uplink signal using the first transmission waveform.
